(19) United States
(12) Patent Application Publication
(10) Pub. No.: US 2006/0090136 A1
(43) Pub. Date: Apr. 27, 2006

(54) Methods and apparatus for implementing a virtualized computer system

(75) Inventors: Matthew E. Miller, Kirkland, WA (US); Sven Hallauer, Sammamish, WA (US); Claus Steen Joergensen, Kirkland, WA (US); Richard Webb, Lynnwood, WA (US)

Correspondence Address: WOLF GREENFIELD (Microsoft Corporation);C/O WOLF, GREENFIELD & SACKS, P.C., FEDERAL RESERVE PLAZA, 600 ATLANTIC AVENUE, BOSTON, MA, 02210-2206, US

(73) Assignee: Microsoft Corporation, Redmond, WA (US)

(21) Appl. No.: 10/956,496

(22) Filed: Oct. 1, 2004

(51) Int. Cl. G06F 9/00

(52) U.S. Cl. 715/734

(57) ABSTRACT

In one aspect, a method of creating a virtualized computer environment that represents a real world computer environment is provided. The real world computer environment comprises a plurality of components, the plurality of components comprising a plurality of computer devices and at least one network device that implements a network that interconnects the plurality of computer devices, the real world computer environment comprising at least one security facility that implements at least one security function in the real world computer environment. The method comprises acts of including in the virtualized computer environment a virtualized representation of at least one of the plurality of computer devices in the real world computer environment and implementing the at least one security function in the virtualized computer environment. In another aspect, a virtualized representation of the at least one network device is provided. In another aspect, software is executed in the virtual computer environment.

### FIELD OF THE INVENTION

The present invention relates to a virtualized computer system for developing and/or testing software.

### BACKGROUND OF THE INVENTION

Networked computer systems play important roles in the operation of many businesses and organizations. A computer system refers generally to any collection of one or more devices interconnected to perform a desired function, provide one or more services, and/or to carry out various operations of an organization, such as a business or corporation. An enterprise system, for example, may support one or more operations of a business or enterprise, such as providing the infrastructure for the business itself, providing services to the business and/or its customers, etc. A computer system may include any number of devices connected locally or widely distributed over multiple locations, and may operate in part over a local area network (LAN), a wide area network (WAN), the Internet, etc., to provide a computing environment for the enterprise. For example, a standard business enterprise system may include several distributed sites such as a central corporate site and a plurality of branch office sites, each branch office including different populations of end-users.

A computer system may operate, in part, by executing one or more software applications that, for example, provide services to users of the computer system. It may be difficult for software developers, and in particular, developers of enterprise or business applications to predict how software will operate in a given computing environment when installed and operated on a customer's computer system. As a result, issues and conflicts between the software and a particular computer system may not be identified until the software is already released and deployed on the computer system. To improve the fidelity of testing software, conventional testing schemes may include building a physical replica of a target computing environment on which to test the application.

### SUMMARY OF THE INVENTION

One aspect according to the present invention includes a method of creating a virtualized computer environment that represents a real world computer environment, wherein the real world computer environment comprises a plurality of components, the plurality of components comprising a plurality of computer devices and at least one network device that implements a network that interconnects the plurality of computer devices, the real world computer environment comprising at least one security facility that implements at least one security function in the real world computer environment. The method comprises acts of including in the virtualized computer environment a virtualized representation of at least one of the plurality of computer devices in the real world computer environment, and implementing the at least one security function in the virtualized computer environment.

Another aspect according to the present invention includes a computer readable medium encoded with a program for execution on at least one processor, the program, when executed on the at least one processor, performing a method of providing a virtualized computer environment that represents a real world computer environment, wherein the real world computer environment comprises a plurality of components, the plurality of components comprising a plurality of computer devices and at least one network device that implements a network that interconnects the plurality of computer devices, the real world computer environment comprising at least one security facility that implements at least one security function in the real world computer environment. The method comprises acts of providing in the virtualized computer environment a virtualized representation of at least one of the computer devices in the real world computer environment, and performing the at least one security function in the virtualized computer environment.

Another aspect according to the present invention includes an apparatus for deploying a virtualized environment that represents a real world computer environment, wherein the real world computer environment comprises a plurality of components, the plurality of components comprising a plurality of computer devices and at least one network device that implements a network that interconnects the plurality of computer devices, the real world computer environment comprising at least one security facility that implements at least one security function in the real world computer environment. The apparatus comprises at least one controller adapted to emulate at least two of the plurality of computer devices in the real world computer environment and to implement the at least one security function in the virtualized computer environment.

Another aspect according to the present invention includes a method of testing software to be executed on a real world computer environment that comprises a plurality of computer devices interconnected via a network that comprises at least one network device, the real world computer environment further comprising at least one security facility that implements at least one security function in the real world computer environment, the method comprises an act of executing the software on a virtualized computer environment that represents the real world computer environment, the virtualized computer environment comprising a virtualized representation of at least one of the computer devices in the real world computer environment and implementing the at least one security function in the virtualized computer environment.

Another aspect according to the present invention includes a method of creating a virtualized computer environment that represents a real world computer environment, wherein the real world computer environment comprises a plurality of components, the plurality of components comprising a plurality of computer devices and at least one network device that implements a network that interconnects the plurality of computer devices. The method comprises acts of providing virtualized representations of at least two of the plurality of computer devices, and providing a virtualized representation of the at least one network device to provide a virtualized network.

Another aspect according to the present invention includes a computer readable medium encoded with a program for execution on at least one processor, the program, when executed on the at least one processor, performing a method of creating a virtualized computer environment that represents a real world computer environment, wherein the real world computer environment comprises a plurality of components, the plurality of components comprising a plurality of computer devices and at least one network device that implements a network that interconnects the plurality of computer devices. The method comprises acts of providing in the virtualized computer environment a virtualized representation of at least two of the plurality of computer devices and providing in the virtual computer environment a virtualized representation of the at least one network device to provide a virtualized network.

Another aspect according to the present invention includes a method of testing software to be executed on a real world computer environment that comprises a plurality of computer devices interconnected via a network that comprises at least one network device. The method comprises an act of executing the software on a virtualized computer environment that represents the real world computer environment, the virtualized computer environment comprising a virtualized representation of at least two of the plurality of computer devices and a virtualized representation of the at least one network device in the real world computer environment.

Another aspect according to the present invention includes an apparatus for deploying a virtualized environment that represents a real world computer environment, wherein the real world computer environment comprises a plurality of components, the plurality of components comprising a plurality of computer devices and at least one network device that implements a network that interconnects the plurality of computer devices. The apparatus comprises at least one controller adapted to virtualize at least two of the plurality of computer devices and to virtualize the at least one network device to provide a virtualized network.

### BRIEF DESCRIPTION OF THE DRAWINGS

FIG. 1 illustrates a physical host machine implementing a pair of virtual machines;

FIG. 2A illustrates a computer system comprised of first and second computers interconnected via a network connection;

FIG. 2B illustrates the computer system of FIG. 2A virtualized on a physical host machine, in accordance with one embodiment of the present invention;

FIG. 3A illustrates a computer system connected to a switch in a star configuration;

FIG. 3B illustrates the computer system of FIG. 3A virtualized on a physical host machine, in accordance with one embodiment of the present invention;

FIG. 4 illustrates a computer system distributed between four security zones and connected to the Internet;

FIG. 5 illustrates the computer system of FIG. 4 virtualized on a physical host machine, in accordance with one embodiment of the present invention;

FIG. 6 illustrates a computer system including components and services for testing a software application;

FIG. 7 illustrates the security environment of the computer system of FIG. 6;

FIG. 8 illustrates the computer system and security architecture of FIGS. 6 and 7 virtualized on a physical host machine, in accordance with one embodiment of the present invention;

FIG. 9 illustrates a computer system designed in accordance with the Microsoft Systems Architecture v2.0;

FIG. 10 illustrates a core subset of the components and services of the computer system in FIG. 9;

FIG. 11 illustrates the core subset of FIG. 10 virtualized on a plurality of physical host machines, in accordance with one embodiment of the present invention;

FIG. 12 illustrates another view of the core subset of FIG. 10 virtualized on a plurality of physical host machines, in accordance with one embodiment of the present invention, with the virtual connections between virtual machines within a single host device suppressed;

FIG. 13 illustrates the security environment of the computer system of FIGS. 9 and 10 and the virtualized computer system of FIGS. 11 and 12;

FIG. 14 illustrates the organizational unit (OU) design of the computer system of FIGS. 9 and 10;

FIG. 15 illustrates the internal OU design used for the top tier of the North America, Europe, and Asia Pacific domains of the computer system in FIG. 9; and

FIG. 16 illustrates the perimeter OU design used for the top tier of the perimeter domain in FIG. 9.

### DETAILED DESCRIPTION

As discussed above, a software application may be tested by executing the software on a physical replica of a target computer environment or data center on which the application is intended to run. However, building a replica of a computer environment may be prohibitively expensive. For example, replicating a $100 million dollar enterprise system may cost $20 million dollars. Furthermore, the replica provides a development and testing harness for only a single environment. The cost of testing an application for multiple environments may be prohibitive. However, results obtained from testing an application outside the data center (or a replica of the data center) may not accurately reflect how the application will behave in the environment on which it will ultimately be deployed.

Applicant has recognized that at least some of the difficulties in predicting how an application or service will behave in a particular environment arise from network and security settings. In one embodiment according to the present invention, a virtualized environment of a computer system having at least two computers coupled by a network connection is provided, wherein the network connectivity between the at least two computers is virtualized. In many networked computer systems, security features are imposed on the computer system. In another aspect of the invention, at least one security feature of the computer system is implemented in the virtualized environment. By virtualizing the network environment and security of the computer system, an application or service may be more reliably tested, and errors associated with the application operating on the computer system may be identified and fixed during test cycles before the product is released to internal and/or external customers.

The term “virtualize” refers herein to acts of emulating at least some of the behavior and/or characteristics of a physical object in software. Accordingly, a “virtualized representation” refers to one or more software components that emulate or model the behavior of a physical object, such as a computer or network device.

Many computer systems share a core of functionality that, while implemented differently (i.e., implemented using different physical component vendors, different protocols and standards, etc.), may be common to a wide range of environments, (e.g., common to a wide variety of enterprise systems). This shared core may play a significant role in any test environment for an application or service intended to operate in the environment. In one embodiment, a testing environment is provided by virtualizing one more core components and/or services of a computer environment that can be configured to emulate the physical counterpart in the physical environment being virtualized. The virtualized core may be reconfigured to emulate different computer environments without having to change the physical equipment to match the different environments, as is the case with the conventional physical data center. As a result, the expense of physically building and implementing the core functionality may be significantly reduced. In addition, the virtualized core may be reconfigured to emulate various implementations of the core functionality.

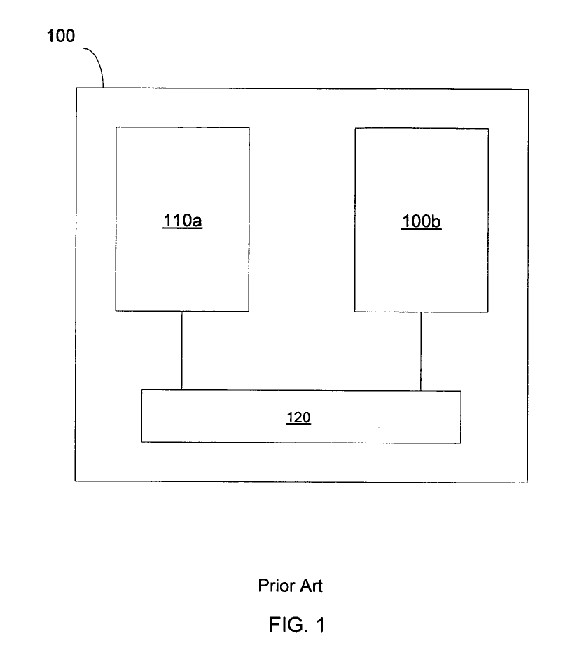

Virtualized machines (VM) have been employed to facilitate multi-user environments. For example, one or more computers running different operating systems on different hardware may be virtualized on a single physical machine. FIG. 1 illustrates a conventional scenario in which a pair of VMs operate on a single physical machine 100. VM 110a may emulate a Windows machine, while VM 110b may emulate a UNIX environment. A translation layer 120 may be provided that allows each of the operating environments to communicate with the same hardware (i.e., physical machine 100). In a computing environment where multiple users share a single machine, each user can logon to machine 100 and operate in whichever environment the user chooses.

It should be appreciated that while multiple machines are virtualized, the VMs are substantially independent and do not communicate with one another as if they were connected over a network. Conventional virtualization may include virtualization of individual machines on a host, but does not include virtualization of a computer system, and more particularly, does not include virtualization of a complete and robust networked computer system. For example, physical machine 100 does not virtualize network connectivity between the VMs that it hosts.

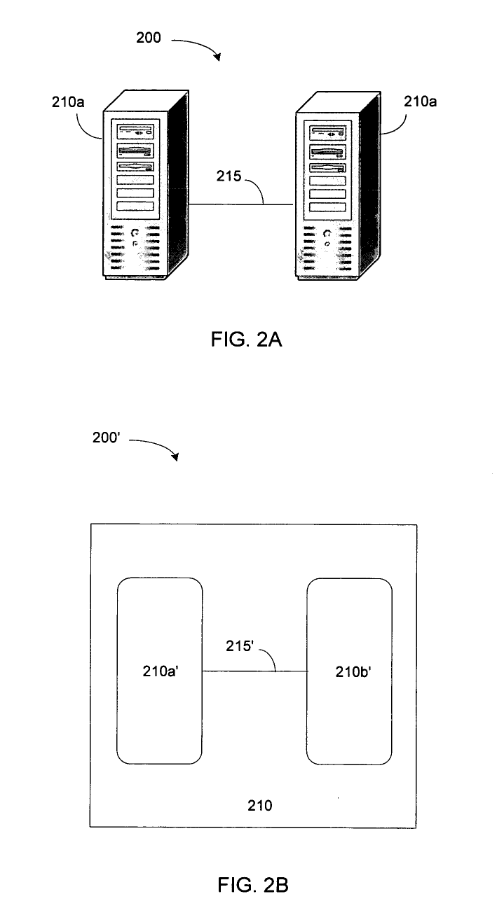

FIG. 2A illustrates a computer system 200 comprising computers 210a and 210b connected together by network connection 215. Network connection 215 may be any physical medium capable of transmitting information between physical computers 210a and 210b. For example, network connection 215 may be an electrical medium such as category 5 (CAT5) cable, a fiber optic cable, or a wireless connection. Computers 210a and 210b may communicate over network connection 215 according to any desired protocol or standard and may be connected to one or more additional computers via other network connections (not shown). Computers 210a and 210b may be located proximate or remote from one another. For example, computers 210a and 210b may be located in the same room, connected over a LAN in separate rooms of an office building, or located in an entirely different geographical locale, for example, in different cities connected via the Internet.

FIG. 2B illustrates a virtualized computer system 200′, in accordance with one embodiment of the present invention, that may emulate, at least in part, the behavior of computer system 200. For example, VM 210a′ may emulate computer 210a and VM 210b′ may emulate computer 210b. Both VMs may be virtualized on the same physical machine 210 or on different physical machines. The network connectivity of computer system 200 is virtualized by virtual network connection 215′. Virtual network connection 215′ may include one or more software components or programs configured to transmit information between VM 210a′ and VM 210b′. From the standpoint of the virtual machines, virtual network connection 215′ operates as if the VMs were distinct physical machines communicating over a physical network connection. Accordingly, the interaction between multiple computers connected over a network (i.e., a computer system) is virtualized.

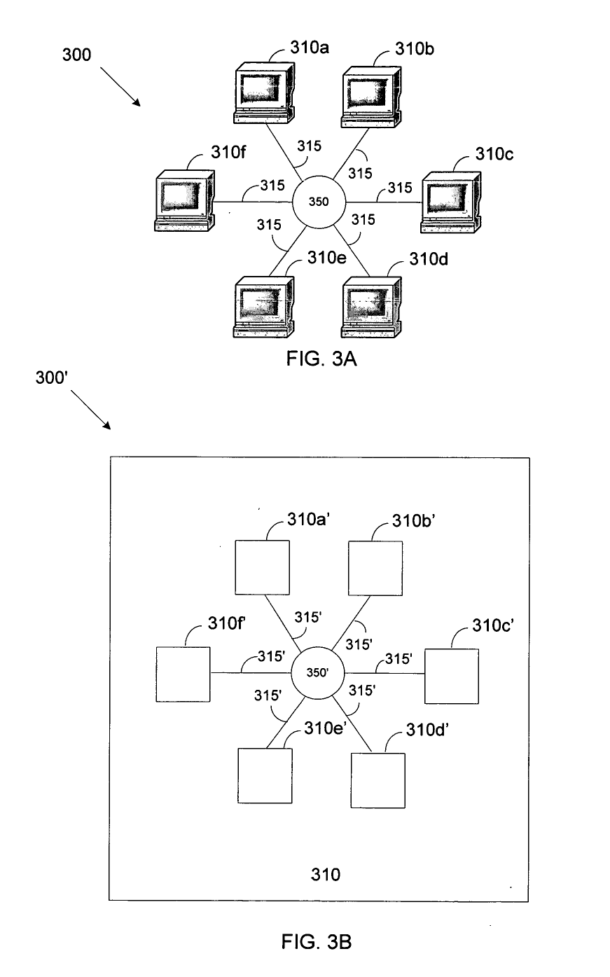

It should be appreciated that a computer system having any number of computers connected in any network configuration or topology may be virtualized. For example, FIG. 3A illustrates a networked computer system 300 in a star configuration. Computers 310a-310f are connected through a switch 350 via network connections 315. FIG. 3B illustrates a virtualized network 300′ having the components of network 300 emulated on physical machine 310. In particular, VMs 310a′-310f′ emulate computers 310a-310f. Virtualized switch 350′ may include one or more software components that model the behavior of switch 350 such that network communications and behavior can be simulated via virtual network connections 315′. It should be appreciated that any type of network component may be virtualized (e.g., switches, hubs, routers, etc.) to simulate any desired network configuration, as the invention is not limited in this respect. Any physical component or object whose behavior can be modeled, at least in part, in software may be virtualized.

As discussed above, software applications developed for operation on a computer system are more likely to fail when installed and executed in real-life environments if the application has not been tested on a replica of the target environment. Applicant has recognized that applications often fail due to the unknown behavior of the application in the network environment of the computer system on which the application is ultimately installed, based on security or other functionality of the network.

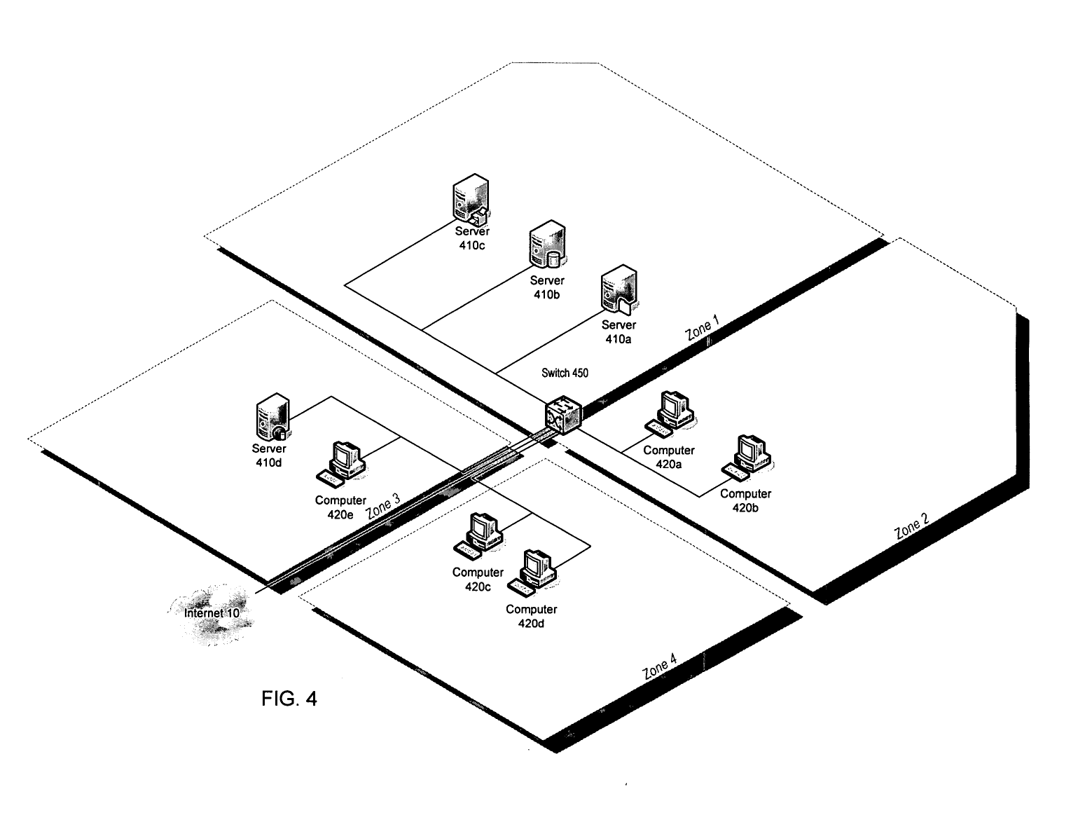

FIG. 4 illustrates an exemplary computer system 400 operating in at least four different security zones 1-4. Security zone 1 includes server 410a, server 410b, server 410c, which can be any type of servers. For example, a file server, a database server, and a print server, respectively. The servers may provide a number of services and/or resources to computers in other zones. The computers in zone 1 may be connected to computers and other components in other zones through switch 450. The computers in zones 1-4 may form a local area network (LAN), or a wide area network (WAN) and may located proximate or remote from one another. Computer system 400 may also be connected to other networks, such as the Internet, illustrated schematically by Internet 10. Zones 2, 3 and 4 include a plurality of computers 420a-420d that may access data and/or services provided by the servers in zone 1 and/or communicate with devices in other zones or over the Internet. For example, computers 420 may be personal computers (PCs) of users, clients and/or customers of one or more services, such as various business or enterprise applications, databases, network services, etc. Zone 3 also includes a server 410d connected to computer system 400 via switch 450.

Each of zones 1-4 may have a separate security designation. For example, zone 2 may have privileged access to certain data and/or services that zone 4 does not. The computers connected in zone 1 may treat zone 1 as a trusted environment, while treating zone 3 as a semi-trusted environment. Similarly, zone 1 may treat zone 4 as an untrusted environment and employ stringent access and verification security features when interacting with zone 4. Each of the zones may attribute different security levels with respect to the Internet, and with respect to the other zones. As a result, the security landscape of computer system may be relatively complex. To implement a desired security environment, one or more of the devices in a security zone may perform one or more security functions that, for example, limit access, execute one or more security features such as password verification, encryption, etc.

Predicting how an application will behave in the security environment of computer system 300 may be difficult, while building a data center to replicate computer system 400 may be expensive. In addition, the application being tested may be intended for operation not only on computer system 400, but on a variety of different computer systems having varying security environments. Building a data center for each network and/or security environment may not be desirable or even feasible.

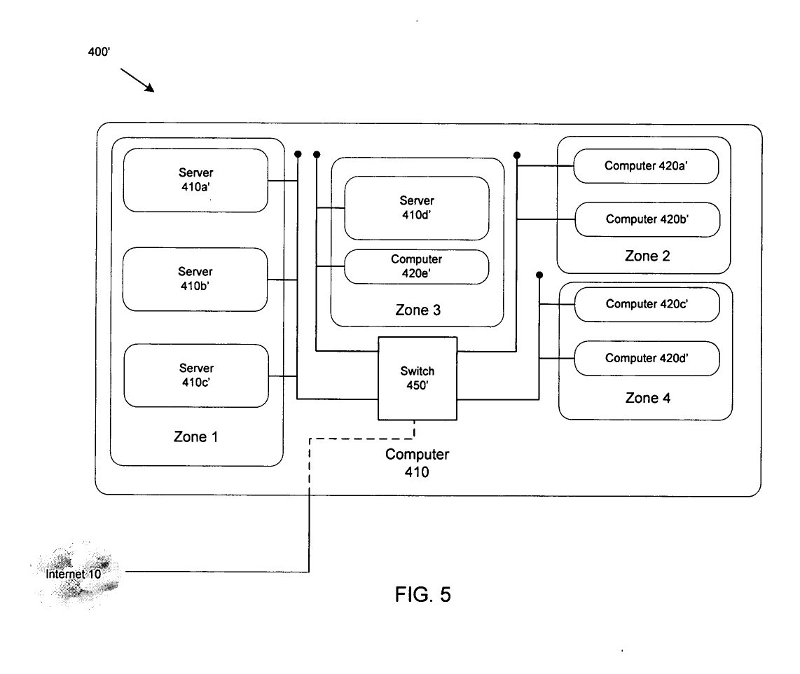

FIG. 5 illustrates a virtualized computer system 400′ in accordance with one embodiment of the present invention. Virtualized computer system 400′ emulates computer system 400 illustrated in FIG. 4. Virtualized computer system 400′ may be implemented on a single computer 410 as shown in FIG. 5 or may be implemented on multiple computers as illustrated in further embodiments described below.

As discussed above, network connectivity may be virtualized by implementing virtual switch 450′. From the standpoint of the different virtualized computers and any application running on the virtualized computers, the network appears to be an actual physical network of distinct physical machines serviced by a physical switch. That is, each computer or server communicates with the network and operates as if it were a physical machine connected to a physical network. Computer 410 may optionally be connected to internet 10, or may operate in isolation from physical networks. For example, the virtualized environment may be connected to the Internet by implementing a network connection between switch 450′ and the Internet. This connection allows the virtualized environment to test with interfaces that are only supplied from the Internet In addition, the security environment of computer system 400 may be implemented on or incorporated into the virtual network of virtualized computer system 400′. For example, zones 1-4 may be established in virtualized computer system 400′ such that the same access privileges and security features of computer system 400 operate in the virtualized system. An application configured to provide one or more services to computer system 400 may be tested on virtualized computer system 400′ without having to replicate the entire environment physically. Because the network configuration and security environment is emulated, the behavior of the application on virtualized computer system 400′ may better predict the application's behavior when deployed on computer system 400. Since the network and connections are virtualized, they can be programmed to operate according to any protocol, using any type of connection, in any type of configuration subject to any desired security functions. Accordingly, testing the application on a number of virtualized systems and environments may be achieved by reconfiguring the virtualized components or replacing them with virtualized components that together emulate the desired computer system having the desired security environment on which to test the application.

Many enterprise applications, such as n-tier applications, rely on one or more services provided by the computer system on which the application is executed, for example, one or any combination of IT fundamentals such as network architecture, security architecture, directory service, DNS, firewall, proxy, etc. Due to dependencies of many enterprise applications on services provided by the underlying computer system, adequately testing an enterprise application often requires deploying the software on a replicated system. Providing a reference deployment environment that provides one or more services to an enterprise application virtually may obviate the need to build relatively expensive data centers to replicate a target networked computer environment.

In one embodiment, a subset of IT operational principles and architectures is provided in a virtualized deployment environment. In building the environment, the architectural elements and services needed for an application to be tested are determined. This process may include determining what services are required by the application and/or what dependencies the application has on the target computer environment. The virtualized deployment environment may then be created to provide a test harness for the application without having to build a replica of the target computer environment.

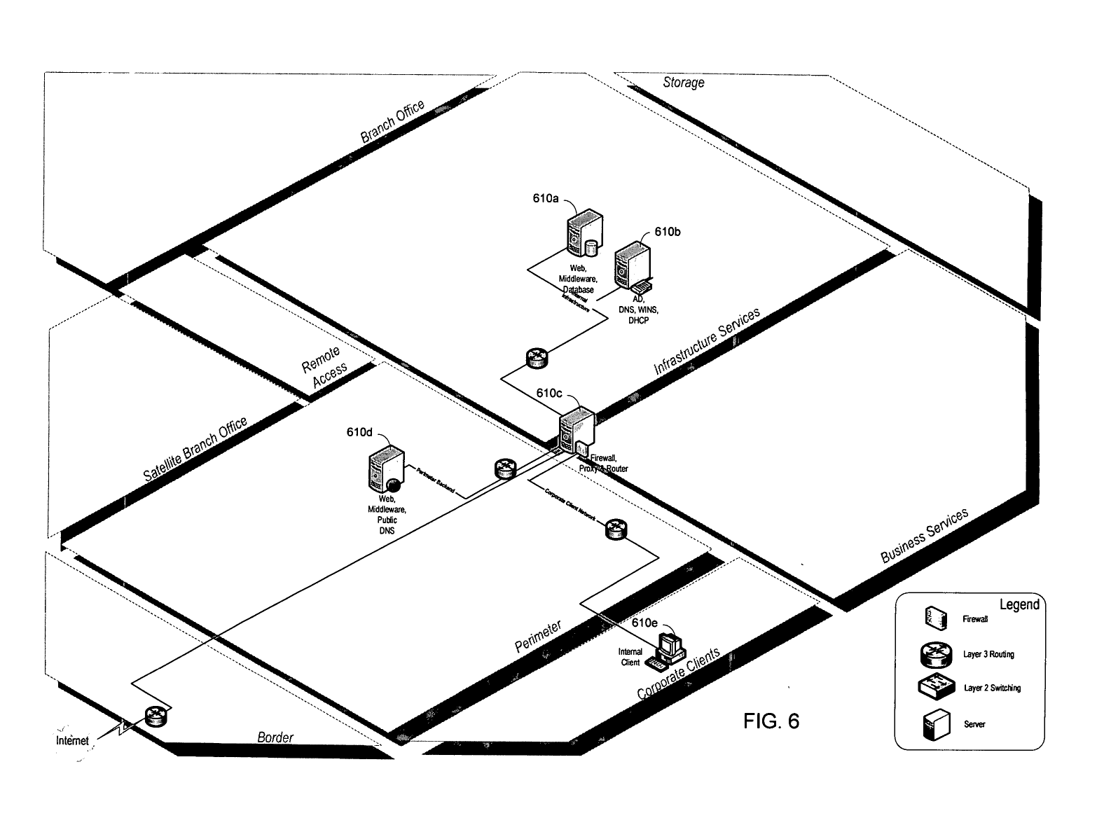

FIG. 6 illustrates a portion of a networked computer system 600 including a collection of architectural elements and services that are included in accordance with one embodiment of the invention because they are believed to be useful in supporting an enterprise application. However, the invention is limited in this respect as any number of components, services and/or functionality may be added or removed to form a basis for a real world computer system to be represented in a virtualized environment.

The computer system includes a plurality of servers 610a-610d and a client computer 610e. The servers provide services including web, middleware and database services (e.g., via server 610a), AD, DNS, WINS, and DHCP services (e.g., via server 610b), firewall, proxy and routing services (e.g., via server 610c), and public DNS (e.g., via server 610d). System 600 may include a security landscape segmented as shown by the security zones where the computer assets are located. Network system 600 is one example of at least a subset of a real world computer environment on which enterprise software may be intended to be deployed.

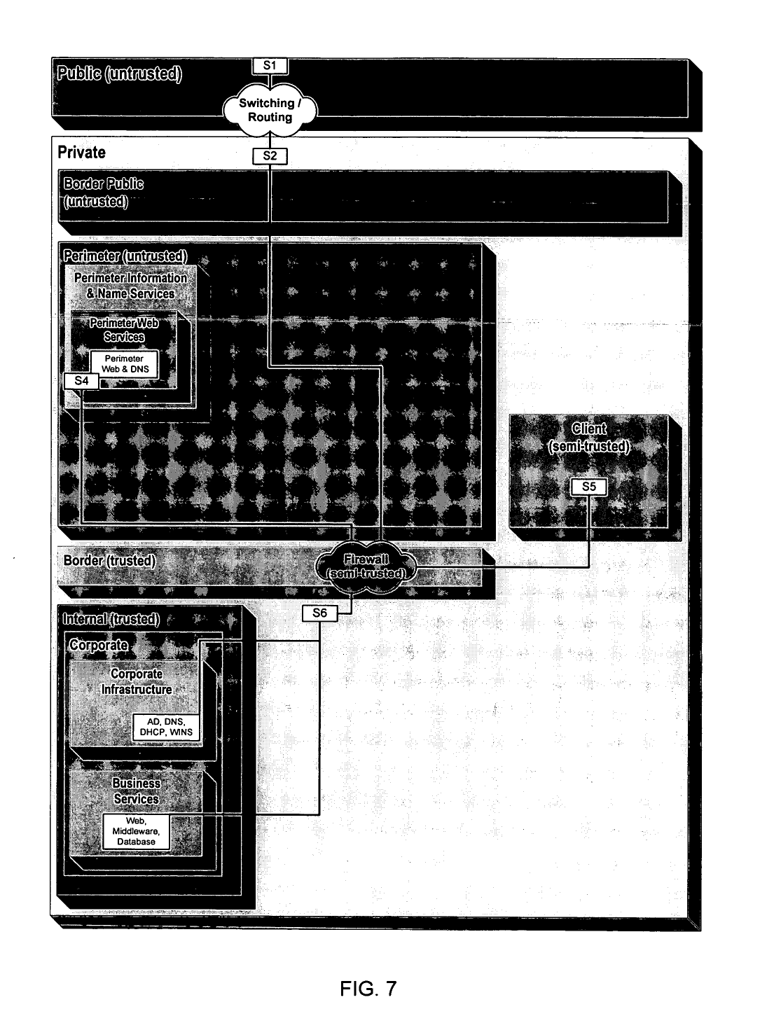

FIG. 7 illustrates the security environment of the networked computer system in FIG. 6. The security environment comprises a number of tiers within each security zone. A tier is defined as a logical entity comprised of one or more hosts or devices that provide similar functionality and which may be addressed as a single entity by other hosts, devices, and users. The security environment in segmented into a plurality of zones. Internet-connected computer systems typically have at least public, private, internal, and perimeter zones.

The public zone contains tiers that are not under the control of the enterprise. For example, the Internet and its connection to the external interface of the computer system's Internet-connected border routers are defined as the public zone. Information in the public zone is freely available to the public and does not need specific access rights. As such, this segment of the network, labeled as S1, may not implement any security functions. However, to limit specific outside attacks, for example, some initial security measures are often applied, such as dropping certain designated network communications (e.g., PING and/or any “half-open” TCP packets). The public zone may include the point of origin for customers, for remote employees connecting to the enterprise network through a virtual private network (VPN) or through branch office VPNs, and for business partners.

The private zone includes the connectivity tiers, application tiers, and network segments connected to the internal side of the computer system's Internet-connected routers. The purpose of this zone is to separate the traffic flow internal to the organization from the traffic flow of the Internet (or public zone). The boundary between the private and public zones may include one or more security functions. For example, the boundary between network segment S1 and network segment S2 may include a router on which Open Systems Interconnection (OSI) model layer 3 (L3) access control lists (ACLs) can be implemented to drop unnecessary inbound traffic, as sanctioned by the security policy of network segment S2. The private zone is comprised of perimeter and internal zones.

The perimeter zone contains tiers that may be bounded by some form of access control functionality that isolates the public zone from the perimeter zone and the perimeter zone from the internal zone, thereby also isolating the internal zone from the public zone. The purpose of this zone is to facilitate the creation of security polices within the computer system so that traffic can be filtered between the public and internal zones. The perimeter zone prevents the public from gaining general access to the internal resources of the computer system. This zone is referred to as the perimeter network because it sits between the public network and the internal network and holds semi-trusted information related to the enterprise. The perimeter zone may contain firewall tiers as well as tiers that provide public facing services, such as DNS and Web services.

The internal zone contains all the tiers containing internal data assets, for example, the data assets controlled and owned by a given enterprise such as application data, electronic messaging data, and proprietary databases. The purpose of the internal zone is to isolate the tiers running internal services and clients from the public and perimeter zones. The internal zone is further subdivided into a corporate tier including a corporate infrastructure tier and a business services tier.

The corporate tier separates, for example, enterprise servers from clients to avoid internal security breaches. The network segment S6 may implement access control mechanisms to control the flow of traffic between tiers in this zone and tiers in the client zone, as well as to keep perimeter zone tiers separate from the tiers in this zone. The business services zone includes the database tier and enables implementation of access control mechanisms between database assets and the client zone. The core infrastructure zone contains active directory (AD) and DNS tiers to enable implementation of more granular access control mechanisms between it and the client zone.

The client zone contains all the client tiers and may include personal computers (PCs) and other computing devices such as Pocket PCs. The client zone can be further subdivided into additional zones or tiers. A single semi-trusted zone often is sufficient to implement desired security policies. However, multiple semi-trusted zones may be used to apply distinct security policies for different entry points into the environment, such as for business partners, as well as for different departmental needs, such as human resources or sensitive development projects.

Once security zones are defined, security restrictions and policies can be implemented around them such as tier restrictions within a zone, intra-zone tier communications, inter-zone communications. Sometimes zones inherit restrictions from zones to which they belong. For example, the restrictions applied to the corporate infrastructure zone may include the hierarchy of restrictions applied to the private, internal and corporate zone. The security environment in FIG. 7 is merely an example of a security environment and the aspects of the invention are not limited for use in any particular security environment implemented on any computer system.

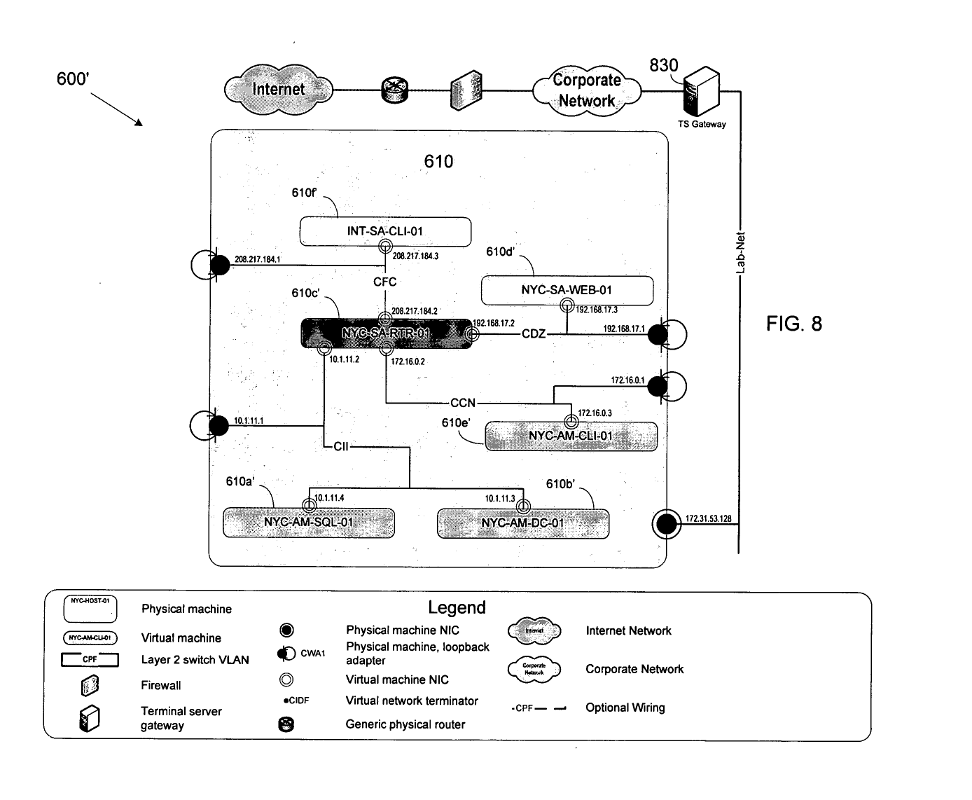

FIG. 8 illustrates a virtualized representation of the computer system in FIG. 6. Virtualized computer system 600′ comprises a physical machine 610 and a plurality of virtual devices 610a′-610f′. The various virtual devices are configured to provide at least some of the services provided by computer system 600. The virtualized devices in FIG. 8 corresponding to respective physical devices in FIG. 6 are given the same reference numeral with a “prime” appended to indicate that they are a virtualized representation of the respective physical devices. In addition to virtualizing the physical devices illustrated in FIG. 6, virtualized computer system 600′ includes a virtualized internet client 610f′ to emulate an Internet client. For example, internet client 610f′ may query the public DNS server or request pages from the public Web server of the computer system.

Each of the virtual devices is labeled with a name that follows the convention <Location>-<Domain>-<Function>-<Sequence>. For example, NYC-AM-SQL-01 indicates that the virtual machine is a representation of a physical machine located in New York City, in the Americas domain, functions as an SQL database server and is the first (and only, in this example) of that type of virtual machine. Accordingly, virtualized device 610c′ (NYC-SA-RTR-01) emulates firewall, proxy and router services and includes DNS service, virtualized device 610d′ (NYC-SA-WEB-01) provides web and middleware services provided within the perimeter zone, virtualized device 610a′ (NYC-AM-SQL-01) provides web, middleware, and database services within the infrastructure services zone, virtualized device 610b′ (NYC-AM-CLI-01) provides the core infrastructure services such as AD, DNS, WINS, DHCP, and virtualized device 610e′ (NYC-INT-CLI-01) is the virtualized internal client in the corporate client zone. Tables 11-13 below include a listing of abbreviations in the naming scheme of virtualized devices.

Each virtual device includes a virtualized network interface card (NIC) denoted by the concentric circles as shown in the legend in FIG. 8. A network address is associated with each NIC and describes to which virtual network the virtual machine belongs. An IP addressing scheme was used and devised to allow for expansion of the environment in any of the networks as needed. Table 1 shows the numbering scheme for the first octet (shown as the decimal representation of the first eight bits) of the internal, perimeter and client zones. The second octet of the address defines the site, the third octet of the address defines the subnet and the fourth octet of the address defines the node within the subnet.

TABLE 1

| Zone/Network | First Octet |
|---|---|
| Internal | 10.x.x.x |
| Perimeter | 192.x.x.x |
| Client | 172.x.x.x |

Software developers may be located in a corporate network remote from the virtual computer environment. To allow such developers access to the virtualized computer environment, corporate clients may logon to the virtualized computer environment through terminal server (TS) gateway 830, which may be connected to one or more physical NICs (e.g., physical NIC at network address 172.31.53.128) of the physical host machine 610. By providing a real world connection to the physical machine hosting the virtualized computer environment, software developers may be able to utilize the virtualized environment remotely (e.g., to test one or more software applications).

In addition, the virtualized computer system may be connected to the Internet, for example, to enable patch updates downloaded from the Internet to one or any combination of the virtual devices. Physical machine 810 also includes several loop back adapters denoted by the symbol shown in the legend in FIG. 8. The loop back adapters allow other virtual networks or physical networks to connect to and communicate with the physical host machine 810.

In FIG. 8, the networked computer system in FIG. 6 is virtualized on a single physical machine 610. As a result, a single machine may replace the relatively expensive hardware comprising computer system 600. In particular, the network connectivity and network devices are virtualized in software on a single physical machine. Since the computer environment may be virtualized on a single machine, in one embodiment, the environment may be installed on a desktop computer to provide a deployment environment for one or more software developers to quickly and easily test software in the virtualized computer environment as the software is being developed.

In addition, the security environment of computer system 600 (i.e., as shown in FIG. 7) may be implemented on the virtualized computer environment 600′, providing a test harness for software deployment such that conflicts with the environment can be detected early and remedied. For example, conflicts with the security environment of real world computer system 600 may be identified during the test phase when the enterprise application is deployed on virtualized computer system 600′.

It should be appreciated that a real world computer system may be virtualized on any number of physical machines, as the invention is not limited in this respect. Thus, the processing load for the virtualized components may be shared amongst multiple physical machines which may communicate in any suitable way (e.g., over one or more physical network connections such as the host machine's physical NIC) to form virtualized computer networks of any variety of configurations, arrangements and complexities.

Virtualized computer system 600′ may be connected to one or more real world components as desired to form a virtualized computer environment including both virtualized and real components. For example, virtualized computer system 600′ may be connected to one or more data storage facilities and/or one or more physical components or services that may have no virtualized representation may be connected to the virtualized computer system to allow for scaling, modifying and/or customizing a virtualized computer environment to fit a particular need or specific testing scenario.

An even more complete and robust computer environment may be modeled to form a virtualized environment that emulates a core of functionality shared by many computer systems, including one or any combination of network architectures, security architectures, network devices, computing devices, network services, directory service, etc. For example, an enterprise system may be implemented according to the Microsoft Systems Architecture (MSA), which provides a blueprint for deploying an enterprise system via architectural components including servers, storage, networking infrastructure, security, software, etc. MSA is described in detail in Microsoft® Systems Architecture v2.0 (MSA 2.0), which is herein incorporated by reference in its entirety. It should be appreciated that MSA based enterprise systems are mentioned only as examples of enterprise systems, as the aspects of the invention described herein are not limited to use with computer systems of any particular architecture, design and/or implementation.

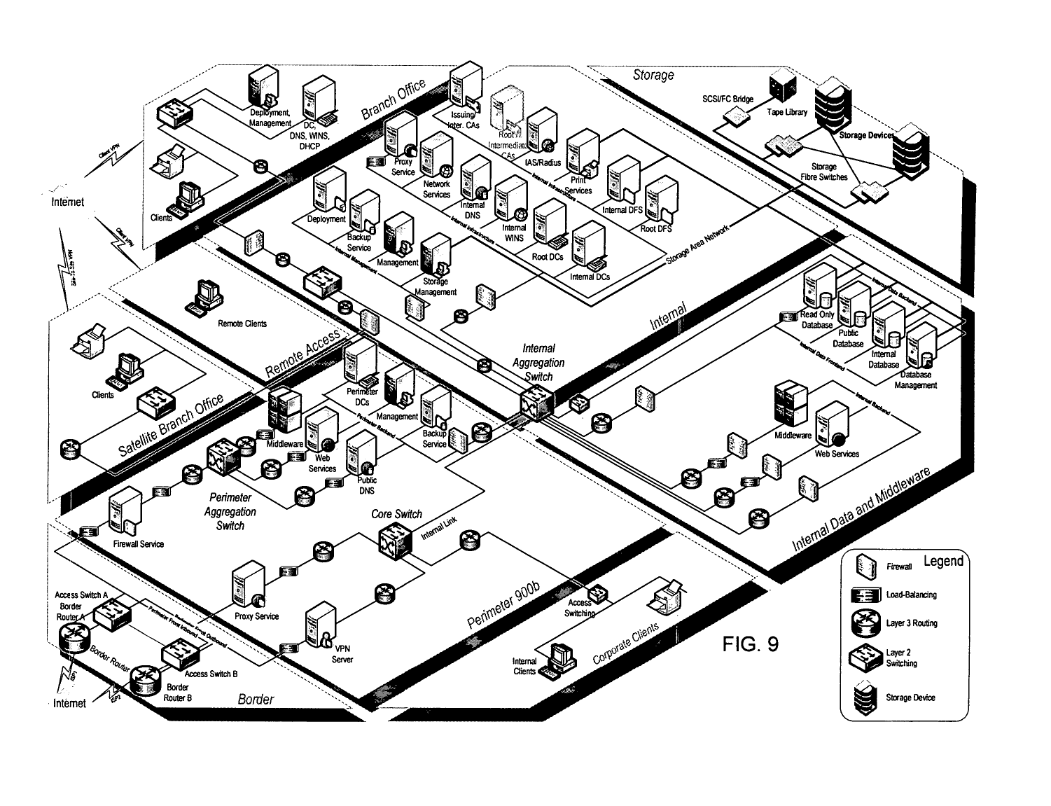

FIG. 9 illustrates an enterprise system 900 architected in accordance with an MSA corporate and branch office enterprise scenario. Enterprise system 900 may be built to support a relatively large enterprise having several and perhaps widely distributed locations. Enterprise system 900 includes a number of different security zones. Enterprise system 900 may support employees of the business via a branch office segment and a satellite branch office segment. The branch office may maintain some degree of IT services locally and the satellite branch office may rely entirely on its network link for services. Enterprise system 900 may support customers, for example, via corporate clients network segment and/or via e-commerce sites and corporate web presence via the Internet. Enterprise system 900 may comprise a heterogeneous environment. For example, various computers may operate using the Windows family of operating systems, while others may operate in UNIX or other operating environments.

Enterprise system 900 also includes an internal zone containing the data assets of the enterprise and perimeter zone which may handle a substantial amount of services between the public and private segments of the enterprise system. Services provided by enterprise 900 may include the services illustrated in Table 2 below. The term “services” refers to herein to both IT services such as directory services, network services, and certificate services, etc., as well as device oriented services such as the hardware services provided by routers, switches, storage, etc.

TABLE 2
Enterprise Services and Resources

| | |
|---|---|
| Network Architecture: Principles for | Directory Service: Microsoft Active |
| designing and implementing a | Directory directory service, including |
| computer communication network. | Active Directory in Application Mode |
| | (AD/AM) |
| Storage Architecture: Principles for | Deployment Services: |
| designing and implementing | Automated Purposing Framework |
| computer storage for a data | (APF), Remote Installation Services |
| center. | (RIS), System Preparation Tool |
| | (SysPrep), and Microsoft Windows |
| | Pre-installation Environment (WinPE) |
| Security Architecture: Principles for | File and Print Services: Distributed |
| designing and implementing security | File System (DFS), network shares, |
| for the computing, networking, and | File Replication Service (FRS), |
| application elements of a data center. | Encrypting File System, and WebDAV |
| Management Architecture: | Data Services: |
| Principles for designing and | Microsoft SQL Server ™ 2000 |
| implementing operations management | |
| of a data center. | |
| Network Devices: | Web Application Services: |
| Routers, switches, and load balancers | Microsoft Internet Information |
| | Services (IIS) |
| Computing Devices: | Infrastructure Management |
| Server hardware classes, and server | Services: |
| configurations. | Debug symbols, Remote Desktop for |
| | Administration, server management |
| | cards, and remote administration |
| Storage Devices: | Backup and Recovery Services: |
| Direct-attached storage (DAS), | Backup software and hardware and |
| network-attached storage (NAS), and | recovery processes |
| storage area networks (SANs) | |
| Network Services: | Certificate Services: |
| Domain Name System (DNS), | Public key infrastructure (PKI) |
| Dynamic Host Configuration Protocol | |
| (DHCP), and Windows Internet Name Service | |
| (WINS) | |
| Firewall Services: | Remote Access Services: |
| Perimeter firewalls, internal firewalls, | Virtual private networks (VPNs) and |
| and proxy/cache services | Internet Authentication Service (IAS) |
| | Middleware Services: |
| | .NET Frameworks, COM+, and |
| | Microsoft Message Queuing (also |
| | known as MSMQ) |

The above services define a core set of services that are often provided by an enterprise system. Enterprise applications operating on an enterprise system may operate within this framework and may rely on one or more of these services. Applicant has appreciated that an effective test environment may be created by identifying and virtualizing the services on which an enterprise application is likely to rely and emulating an environment that contains many of the network variables and security features on which an application is to be tested. While any combination of core services may be chosen to be virtualized, the more service dependencies of an application that are virtualized, the more complete the testing environment becomes.

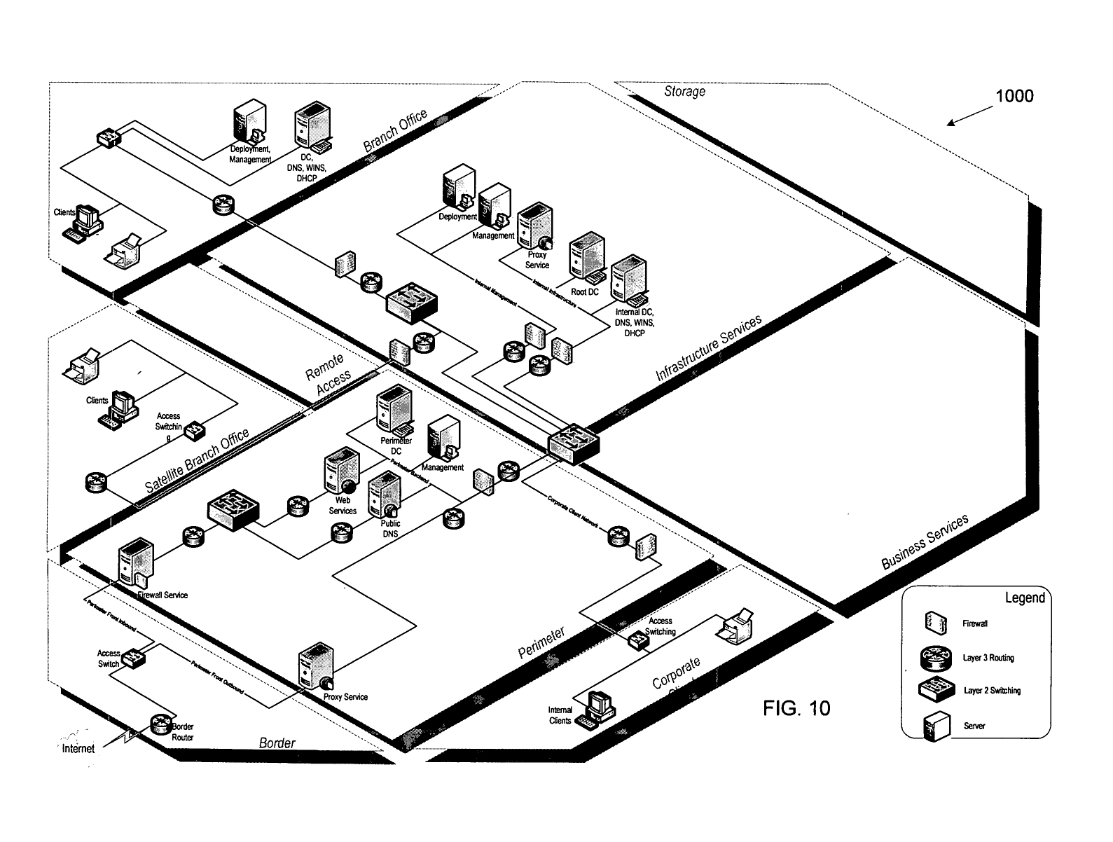

FIG. 10 illustrates a computer system 1000 including a core set of services, referred to as the MiniCore, provided by enterprise system 900 in FIG. 9. Computer system 1000 provides, to some extent, each of the services listed in Table 2. For example, computer system 1000 may include many of the services of a fully featured production environment. By providing a virtualized representation of computer system 1000, a test environment and/or an IT training facility may be provided.

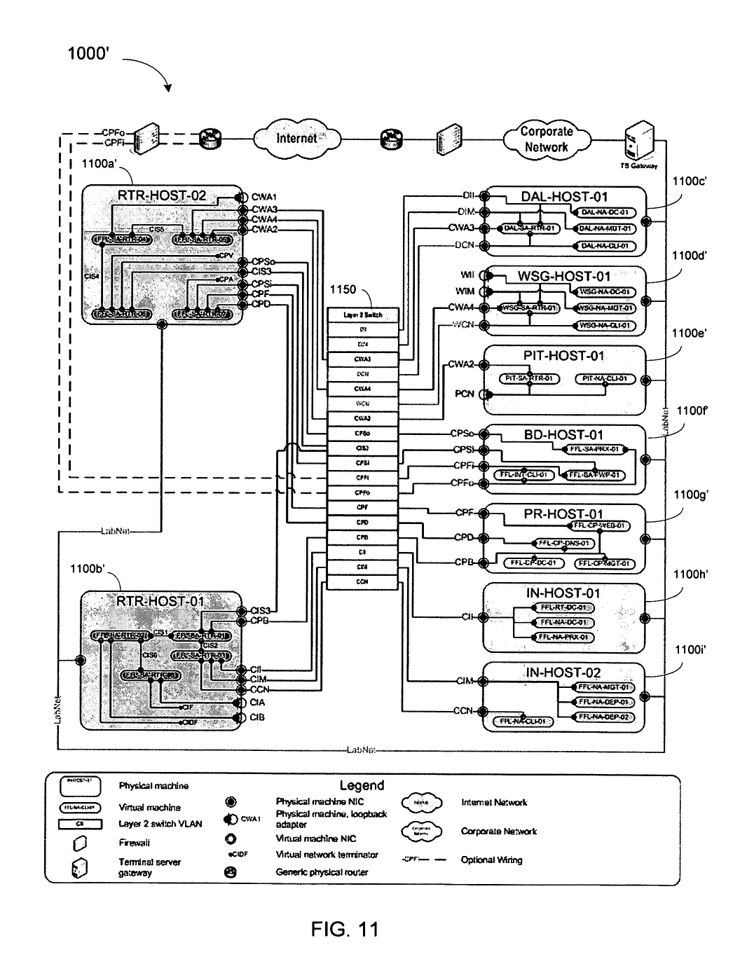

FIG. 11 illustrates virtualized representation 1000′ that virtualizes the core computing environment illustrated in FIG. 10. Since the virtualized representation emulates the core services provided by the computer system in FIG. 10, the virtualized representation illustrated in FIG. 11 is also referred to as the MiniCore. MiniCore 1000′ is virtualized on nine physical host machines 1100a-1100i. The virtualized servers and computer devices resident on the physical host machine are labeled according to the naming convention in Tables 11-13 as described in further detail below.

The physical machines 1100a-1100i hosting the virtualized enterprise environment (also referred to as a production environment) are connected together via physical switch 1150. Because of the relative complexity of the MiniCore, more than a single physical machine may be required or desired to host the virtualized environment. Accordingly, switch 1150 provides a connection between the various virtual components of the environment. The network environment of MiniCore 1000′ is virtualized and is not implemented via the switch 1150. However, since a number of hosts are employed, some physical connection is employed to allow the virtualized components on the different physical host devices to communicate and emulate the real world network behavior of computer system 1000. While a single switch 1150 is used in the example in FIG. 10 to connect the devices, the invention is not limited in this respect, as the devices can be connected in any suitable way.

The virtualized environment illustrated in FIG. 11 also may include a corporate website enabled with access to the MiniCore. The corporate website may have access to the virtualized environment via a TS gateway. As discussed above, this may enable a remote site of software developers to access the MiniCore and test one or more software products or applications on the virtualized environment. In addition, the virtual environment may be connected to the Internet so that, for example, software updates or anti-virus applications may be installed, or patch management procedure may be tested.

It should be appreciated that MiniCore 1000′ provides a wide range of services that an enterprise application may depend on to operate correctly. In addition, MiniCore provides a security environment that may be configured to match that of the real world computer environment on which a software application to be tested will be deployed. Accordingly, many of the factors that cause a software application to fail (i.e., dependencies, security, etc.) are virtualized, and therefore emulated in the MiniCore. Thus, a software application may be tested on the MiniCore with increased assurance that the application will behave substantially the same when deployed in the real world environment. The MiniCore may also be built at a fraction of the cost of replicating the real world enterprise environment that it emulates.

One embodiment of a detailed implementation of MiniCore is described below with reference to MSA 2.0 and the enterprise scenario established therein. The physical host machines, using Microsoft Virtual Server, host and provide the environment for the virtual machines. For the host machines, the general design criteria was to use commodity-class servers that typically have two processors and 2 GB of RAM. Each host machine supports approximately 30-40 GB of disk space to accommodate the virtual machine hard drive files (VHDs). With each virtual machine designed to allocate typically 384 MB of RAM, each host machine should support four virtual machines and still leave enough memory for the host operating system.

The network interfaces on each physical host machine provide the external connectivity for the virtual machines to communicate across hosts. Because a typical commodity-class server supports only two PCI slots and some hosts, such as the ones hosting the router VMs, use a high number of network interfaces, network adapters that support 802.1Q Virtual Local Area Network (VLAN) tagging were used. These adapters allow for less physical network adapters and wiring. It should be appreciated that it is not required to use 802.1Q VLAN tagging in the environment, as the environment may be implemented using standard network adapters and commodity switches or hubs. In implementations using a hub, broadcast domain isolation for VLANs that rely on broadcast protocols such as Dynamic Host Configuration Protocol (DHCP) may be provided.

Network Design

As discussed above, in one embodiment, the MiniCore environment is designed to use physical network devices for only switching and VLAN broadcast domain isolation that host the physical devices that host the virtualized environment. The design does not rely on any physical network devices for routing since all network routing may be implemented using virtual machines with Windows Server 2003 Routing and Remote Access (RRAS). To reduce wiring and the number of physical network ports on each host machine, a corporate-class switch that supports 802.1Q VLAN tagging may be used to provide the connectivity for each of the VLANs. Although this switch supports routing functionality, it may be configured such that no routing is provided.

In the design, each physical host machine may have a network adapter connected to a lab network to allow remote access to the environment. This network is not required to be a routed network and may not interact or route to any of the networks in the virtual environment. Since a production environment is being emulated, the networks implemented in the virtual environment may be isolated from the production corporate networks. For example, an isolated lab network may be used to access the host machines and the virtual networks may be implemented using separate switch devices.

Some host machines may be configured with the Microsoft Loopback Adapter. Having this adapter available allows some virtual networks to connect to and communicate with the host machine. As discussed in further detail below, servicing tasks such as testing for patch management and antivirus services may employ direct access to the host machine so the virtual machines can retrieve updated patches and antivirus signatures. With the host machine directly connected to the same broadcast domain as a virtual machine, no routing is required to access the host and no special firewall rules are required, except for updating the router-firewall virtual machines.

Storage Design

Storage for the MiniCore environment is dependent on the capabilities of Virtual Server and how it supports access to the virtual hard drive files (VHDs). Following the design criteria for commodity server equipment, direct-attached storage was used for the base design. However, Storage Area Network (SAN) storage for the VHD files could be used. Network Attached Storage (NAS) may also be used, but is not recommended because of the increased latency for the disk I/O.

Environment Design

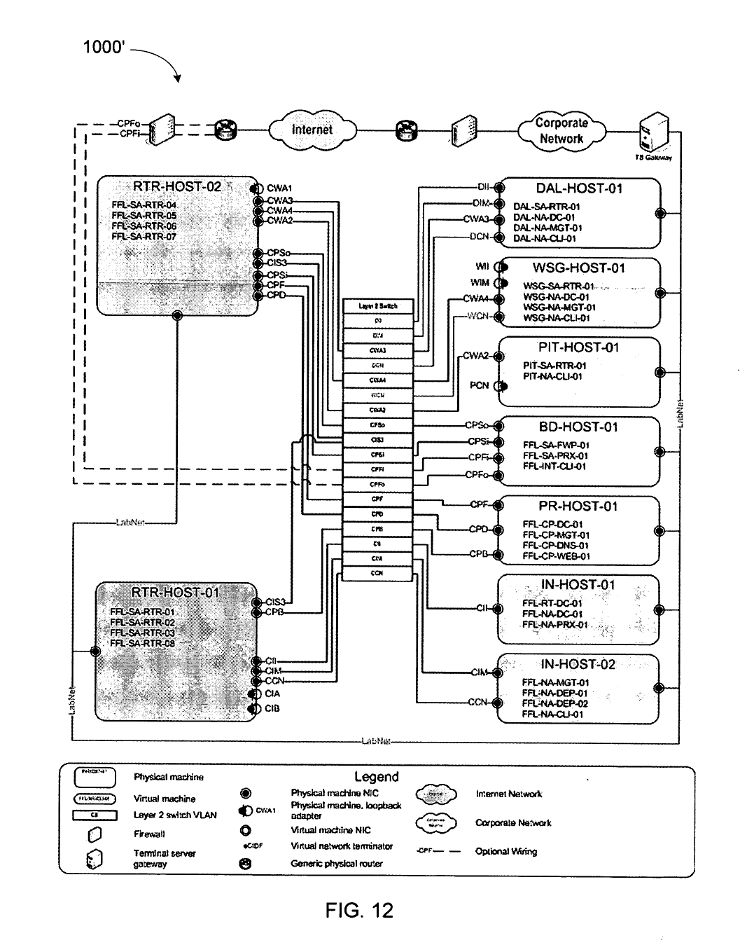

The full environment physical host design consists of all of the servers and networks as depicted in FIG. 12. The network connections are shown as separate VLAN segments. On the host computers, the network connections may be implemented using 802.1Q VLAN tagging NICs to help reduce the number of physical ports required.

FIG. 12 shows the full environment physical host design and can be used by a lab technician to allocate and build the appropriate equipment. Notice that it does not show the connections between the virtual machines that make up the emulated enterprise. For more detail about the network connectivity between the virtual machines, refer to the “Virtualized Physical Design” section below.

FIG. 12 shows an abstracted corporate environment that provides access to the Internet through one or more firewall devices. To isolate the MiniCore environment from the corporate environment, a lab network is connected to the dual-homed terminal server gateway. With this design, a user can use remote desktop from their corporate system to access the terminal server gateway and then use remote access tools to access the individual host and virtual machines. To provide complete isolation, the terminal server gateway does not provide any IP routing between the corporate and lab networks.

In one embodiment, the MiniCore environment does not implement on any of the host machines routing between the lab network and any of the virtual environment networks. To maintain internal integrity and security, IP routing may not be enabled on any of the host machines. FIG. 12 also indicates optional wiring of the CPFi and/or the CPFo networks to the Internet through a firewall. In this configuration, the MiniCore virtual environment can be used to test services that require real Internet resources, such Windows Update services from Microsoft.

Patch Management Design

To enable patch updates to each of the virtual machines, the MiniCore environment provides a patch management solution. Each host machine may be configured with Microsoft Software Update Services (SUS) V1.0 SPI, which runs on top of IIS, to provide a patching source for the Windows Automatic Update Service on each of the VMs. The SUS server on each host machine may be configured to retrieve updates from an upstream SUS server on the lab network, which may receive updates from a corporate patch update server, from Windows Update at microsoft.com, or from other patch update resources. The host SUS server is configured to automatically download the updates but not automatically approve them. This configuration allows you to review the patches before you approve them for update to the virtual machines.

At the root of the C: drive on each virtual machine is a registry update file that, when executed, will update the Windows Automatic Updates registry entries to enable an update cycle restart. Stop and restart the Background Intelligent Transfer Service (BITS) and Automatic Updates service to initiate the patch update cycle. The Windows Automatic Updates service will contact the host SUS server on a predefined interface, specific for each virtual machine, to determine if any updates need to be downloaded. The Windows Automatic Updates registry entries are configured to download the update, but not automatically install it. This gives you the opportunity to observe the patch the update and ensure it installs correctly. The registry updates files are located in the MiniCore Build Files, Auto UpdateConfigs folder.

To enable virtual machine access to the host machine, a virtual network is connected to a host adapter and the host is assigned an IP address on the virtual network. With this design, the virtual machine can locate the host machine on a directly-connected network and does not need to route traffic to the host. This implementation also eliminates any special design within the virtual environment to support patching all the virtual machines. Using this design, the environment does not require a built-in elaborate patch management system and the virtual machines can be patched when the environment administrator chooses.

Antivirus Design

To provide antivirus protection, Computer Associates eTrust 6.0 was installed on all the virtual machines and the host computers. Similar to the patch management design, the host machines provide an FTP download site for the VMs to pull signature updates. The same directly-connected network access method is also used. To improve performance, the Realtime scanner was configured to exclude several Virtual Server file extensions and processes.

Remote Access Design

Virtual Server provides a Web interface for administration and a console interface for each of the virtual machines, the virtual machine remote console utility (VMRC). These tools can be used remotely from a single machine or directly from the host machine. Each host machine may be enabled to have direct access to the virtual environment. The terminal server gateway allows remote access through the lab network to the virtual environment's administration and console interfaces.

Security Design

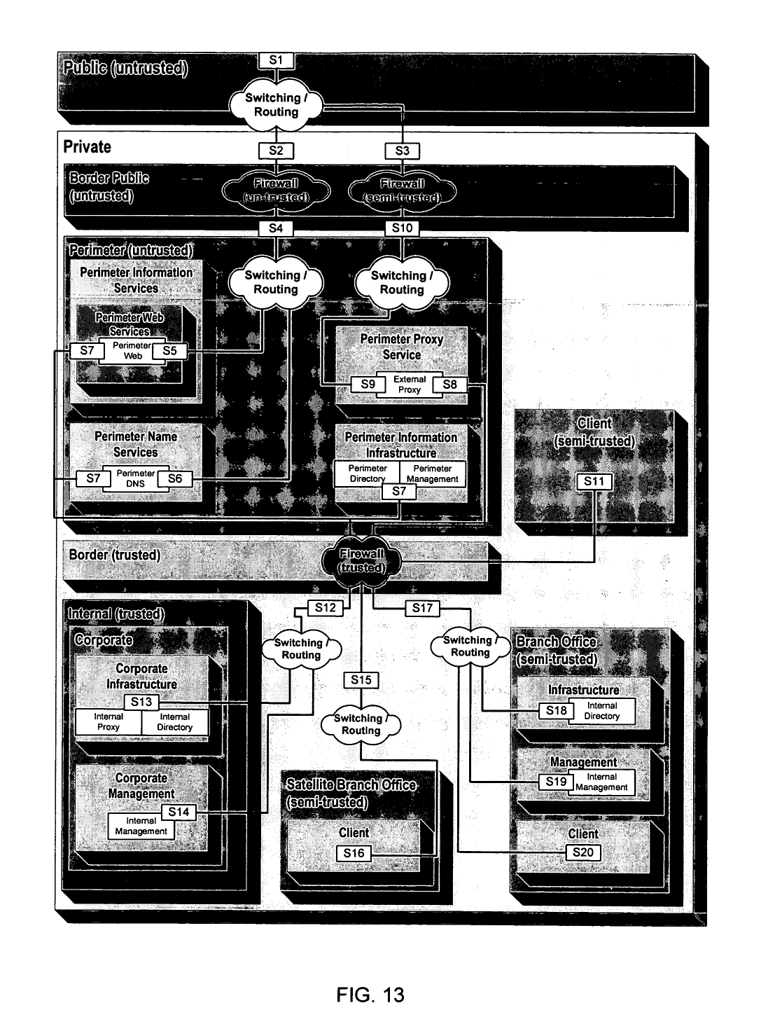

The security design for the Corporate Datacenter (CDC), Branch Office (BO), and Satellite Branch Office (SBO) sites may be based on the security design and assessment from the MSA Security Architecture document in the MSA 2.0 Reference Architecture Kit. In the MSA 2.0 scenario, the security administrator uses the MSA 2.0 guidance to define a number of zones to ensure protection of the organization's IT assets. In the MiniCore, the same process may be used for the CDC, BO and SBO sites. FIG. 13 illustrates an example of zone definitions created and used to define the access policies between each zone.

The logical design consists of the clients and services, mapped into the security zones, as well as the device types providing network connectivity and security. To elaborate on the full environment physical design by adding the virtual machines and networks, FIG. 11 illustrates a full environment virtual design. With this diagram, relative connectivity between the VMs can be seen. FIG. 11 shows one embodiment of the logical design for the MiniCore virtual enterprise environment.

The network connectivity within the virtual enterprise environment was implemented with virtual machines running Windows Server 2003 Standard Edition and Routing and Remote Access Service (RRAS). This design may eliminate any dependence on external physical routing equipment.

To improve operability, dynamic routing updates between the VM routers may be implemented using Open Shortest Path First (OSPF). This design allows more router VMs to be added if necessary to support more networks without having to update each VM with new static routes. The MiniCore design generally followed the OSPF area design implemented on the MSA 2.0 network devices.

Because Virtual Server only supports up to four network adapters per VM, several VM routers may be implemented to support all the network segments designed in the MSA 2.0 scenario. While in one embodiment MiniCore doesn't provide VMs that communicate on every MSA network segment, all the networks were implemented in the routers to allow VMs that connect to those segments to be added.

For example, referring to FIG. 11, all the internal networks are implemented using router VMs named FFL-SA-RTR-01, FFL-SA-RTR-02, FFL-SA-RTR-03, and FFL-SA-RTR-08. These router VMs, plus FFL-SA-RTR-06, encompass the core and access switch-router devices from the MSA 2.0 scenario network design. The router virtual machine FFL-SA-RTR-07 provides routing between the front-side network segments for the perimeter bastion host machines and the back-side network segment for the external firewall server. This router VM implements the perimeter aggregation switch-router device from the MSA 2.0 scenario network design.

For embodiments of the MiniCore environment do not implement a VPN service, connectivity to the satellite branch office (SBO) and other branch offices (BO) can be implemented using emulated direct-connect, leased-line network segments, identified in FIG. 11 as CWA1 through CWA4. The router VMs that handle this traffic are FFL-SA-RTR-04 and FFL-SA-RTR-05.

To simulate the router devices in each SBO and BO site, again RRAS router VMs may be used. The router VMs that handled this traffic are DAL-SA-RTR-01, WSG-SA-RTR-01, and PIT-SA-RTR-01. Each of these routers was also configured with OSPF so that the routes to the segments in the SBO or BO could be advertised to the other routers. OSPF on the WAN interfaces may be configured for point-to-point communication instead of broadcast to reduce traffic on the interface and emulate a real-world implementation.

Each of the SBO and BO router VMs may be configured to use WAN simulator software to emulate link speed, latency, and packet loss as described for the MiniCore scenario. The WAN configurations for each of the sites are described as follows: (1) Dallas (DAL): The WAN connection to Fairfield is 1.54 Mbps (T1) clear-channel, leased line. (2) Washington D.C. (WSG): The WAN connection to Fairfield is 512 Kbps frame-relay, leased line. (3) Pittsburgh (PIT): The WAN connection to Fairfield is 128 Kbps business class DSL. This connection experiences intermittent packet loss of no more than 10% and occasional outages of up to an hour no more than once every 2 months.

A RRAS DHCP Relay Agent protocol may be added to the router VMs that support client and internal server networks. For the WSG and PIT client networks, the DHCP packets are forwarded to the internal corporate DHCP server on the FFL-NA-DC-01 machine. The DAL client network DHCP packets are forwarded to the local DHCP server on the DAL-NA-DC-01 machine.

The RRAS DHCP Relay Agent forwards DHCP packets from all configured interfaces to a globally defined list of DHCP servers. In one embodiment, it could not be configured to forward packets to different DHCP servers for different network segments. Because of this restriction and the resulting router VM design, DHCP packets on the internal networks CII, CIM, and CCN, connected to the FFL-SA-RTR-03 router VM, all forward to the internal deployment servers, FFL-NA-DEP-01 and FFL-NA-DEP-02, and the corporate DHCP server, FFL-NA-DC-01. The DHCP, RIS, and ADS servers resolve the appropriate DHCP scopes and options. For the internal server networks CIA, CIB, CIF, and CIDF, connected to the FFL-SA-RTR-08 and FFL-SA-RTR-02 router VMs, the DHCP packets are only forwarded to the server deployment server, FFL-NA-DEP-01.

To emulate the MSA 2.0 network security, MiniCore uses ISA Server 2004, Standard Edition on all of the FFL-SA-RTR router VMs. The ISA firewall policies are configured to filter packets and no application firewall or proxy features are used. This design emulates the MSA 2.0 scenario implementation of the router access control lists (ACLs) and firewall switch module settings. To emulate Internet routing, RRAS was installed on FFL-INT-CLI-01. This enables the external proxy, FFL-SA-PRX-01, on the CPFo network to make contoso.com Web and DNS requests to the external firewall, FFL-SA-FWP-01, on the CPFi network.

Computing Devices

In one embodiment, the virtual computing devices, configured using Microsoft Virtual Server, use an emulated computing device that is limited to one processor. Each VM is typically configured with 384 MB of RAM and a virtual hard disk (VHD) of 16 GB for the operating system disk. The VHD on the host only consumes as much space as the VM actually uses and will expand to the maximum size of 16 GB.

Because of the emulated hardware, Virtual Server limits the number of network adapters to four per VM. To help identify the adapters in the VM and maintain unique Ethernet Media Access Control (MAC) addresses, an algorithm for defining the VM NIC MAC addresses was devised as outlined below.

00-03-FF-<ZoneGroup>-<Function>-<Instance>

ZoneGroup, Function, and Instance are all 2-digit hexadecimal numbers and follow the IEEE 802.3 Ethernet station address convention. ZoneGroup defines the security zone in which the VM resides; Function defines the VM function; and Instance defines the NIC instance in the VM. The Instance value will always be in the range of 01-04 so you can use this value to identify the NIC with the ipconfig/all command. The actual values used for ZoneGroup and Function are arbitrary and can be in the range of 00-FF (hex).

Table 3 highlights the virtual machines and the functions each provides.

TABLE 3

| | Software | | |
|---|---|---|---|
| Server | Configuration | Network(s) | Function |
| FFL-SA- | W2K3.STD | CIS1, CIS2, | Internal corporate router. |
| RTR-01 | Routing and | CIS3, CPB | |
| | Remote Access | | |
| | Service (RRAS) | | |
| FFL-SA- | W2K3.STD | CIS1, CIS6, | Internal corporate router. |
| RTR-02 | RRAS | CIB, CIDF | |
| FFL-SA- | W2K3.STD | CIS2, CII, | Internal corporate router. |
| RTR-03 | RRAS | CIM, CCN | |
| FFL-SA- | W2K3.STD | CIS4, CIS5, | Internal corporate router. |
| RTR-04 | RRAS | CWA1 | |
| FFL-SA- | W2K3.STD | CIS5, CWA2, | Internal corporate router. |
| RTR-05 | RRAS | CWA3, CWA4 | |
| FFL-SA- | W2K3.STD | CIS3, CIS4, | Internal corporate router. |
| RTR-06 | RRAS | CPSo, CPV | |
| FFL-SA- | W2K3.STD | CPA, CPD, | Internal corporate router. |
| RTR-07 | RRAS | CPF, CPSi | |
| FFL-SA- | W2K3.STD | CIS6, CIA, CIF | Internal corporate router. |
| RTR-08 | RRAS | | |
| FFL-SA- | Windows Server | CPFi, CPSi | External firewall server. |
| FWP-01 | 2003 Standard | | |
| | Edition | | |
| | (W2K3.STD) | | |
| | Internet Security | | |
| | and Accelerator | | |
| | (ISA) Server | | |
| | 2000 | | |
| FFL-SA- | W2K3.STD | CPSo, CPFo | External proxy server. |
| PRX-01 | ISA 2000 | | |
| FFL-INT- | W2K3.STD | CPFo, CPFi | Internet client for testing. |
| CLI-01 | Internet | | Hosts a web site for internal |
| | Information | | clients. |
| | Services (IIS) | | Provides connectivity to the |
| | | | emulated Internet for |
| | | | additional testing. |
| | | | Provides routing between |
| | | | CPFo and CPFi networks. |
| | | | Hosts the root DNS zone and |
| | | | provides forwarder NS records |
| | | | for corporate sites. |
| FFL-NA-DC- | W2K3.STD | CII | Primary domain controller for |
| 01 | | | North America domain. |
| FFL-NA- | W2K3 | CIM | Server deployment server. |
| DEP-01 | Enterprise | | |
| | Edition (EE) | | |
| | Automated | | |
| | Deployment | | |
| | Service (ADS) | | |
| FFL-NA- | W2K3.STD | CIM | Client desktop deployment |
| DEP-02 | Remote | | server. |
| | Installation | | |
| | Services (RIS) | | |
| FFL-NA- | W2K3.STD | CIM | Management/tools server. |
| MGT-01 | | | |
| FFL-NA- | W2K3.STD | CCN | Client for testing. |
| CLI-01 | | | |
| FFL-NA- | W2K3.STD | CII | Proxy server for internal |
| PRX-01 | ISA 2000 | | clients to reach external proxy. |
| FFL-RT-DC- | W2K3.STD | CII | Internal Active Directory |
| 01 | | | forest root Domain controller. |
| FFL-CP-DC- | W2K3.STD | CPB | Perimeter Active Directory |
| 01 | | | forest root domain controller. |
| FFL-CP- | W2K3.STD | CPB | Management/tools server for |
| MGT-01 | Windows | | perimeter servers. |
| | debugging tools | | |
| FFL-CP- | W2K3.STD | CPB, CPD | Public DNS server. |
| DNS-01 | | | |
| FFL-CP- | W2K3.STD | CPB, CPF | Public Web server. |
| WEB-01 | IIS | | |
| PIT-SA- | W2K3.STD | PCN, CWA2 | Router for SBO connectivity to |
| RTR-01 | RRAS | | CDC. |
| PIT-NA-CLI- | Windows XP | PCN | Client for testing |
| 01 | (WXP) | | |
| WSG-SA- | W2K3.STD | WII, WIM, | Router for inter-BO |
| RTR-01 | RRAS | WCN, CWA3 | communication and |
| | | | connectivity to CDC. |
| WSG-NA- | WXP | WCN | Client for testing |
| CLI-01 | | | |
| WSG-NA- | W2K3.STD | WIM | Management server and local |
| MGT-01 | | | site application deployment |
| | | | server |
| WSG-NA- | W2K3.STD | WII | Domain controller and DNS |
| DC-01 | | | for Washington DC site. |
| DAL-SA- | W2K3.STD | DII, DIM, | Router for inter-BO |
| RTR-01 | RRAS | DCN, CWA4 | communication and |
| | | | connectivity to CDC. |
| DAL-NA- | WXP | DCN | Client for testing |
| CLI-01 | | | |
| DAL-NA- | W2K3.STD | DIM | Management server and local |
| MGT-01 | | | site application deployment |
| | | | server |
| DAL-NA- | W2K3.STD | DII | Domain controller, DNS, |
| DC-01 | | | DHCP and WINS Services for |
| | | | the Dallas site. |

Active Directory replication depends on Kerberos, which requires less than a five-minute time skew between machines. For the Windows Time Service to synchronize time properly across all the virtual machines, the “Host time synchronization” feature of Virtual Server should be disabled. This feature, when enabled, has each virtual machine synchronize its time to its host machine's time rather than the default of Active Directory domain controllers.

To disable the “Host time synchronization” feature, the check-box on the “Virtual Machine Additions Settings” page from the Virtual Server Administration web page should be unchecked. This setting is set on each of the virtual machines in Table 3, by editing their configuration after they have been shut down. It is not necessary to disable “Host time synchronization” for the FFL-SA-RTR-01 to FFL-SA-RTR-08 machines since they are stand-alone and provide only routing services.

Storage Devices

Direct Attached Storage (DAS) is the only storage model used in one embodiment of the MiniCore design, although other storage models can be employed. Each of the virtual machines is configured to use IDE local hard disks. Because of the emulated machine design, Virtual Server supports up to four IDE devices on two controllers and one device is the emulated CD/DVD-ROM drive. Therefore, three local hard disks are configured. MiniCore does not use the emulated SCSI adapter, which support more local hard disks. All local hard disks use standard basic partitions. MiniCore does not use any RAID configuration for any of the local hard disks.

Services Design

This section provides the design of the services implemented in the MiniCore virtual enterprise environment. Each of these services were instantiated following the guidance in the MSA 2.0 Service Blueprints, Planning Guide, and Build Guide documents. The general guideline was to build an emulated environment that closely matches the physical one built for the MSA 2.0 scenario.

Deployment Services

The MiniCore environment provides deployment services for both server and desktop clients. Guidance from the Microsoft Solutions for Management (MSM) documentation set was used to build the necessary deployment server VMs in the MiniCore.

Server Deployment Design

The MiniCore server deployment service was implemented following the guidance described in the MSM Windows Server Deployment (WSD) 1.0 Solution Accelerator document titled Plan, Build, Deploy, and Operate Guide, which is herein incorporated by reference in its entirety. The deployment server FFL-NA-DEP-01 was installed with a DHCP server and Microsoft Automated Deployment Service (ADS), which provides PXE and TFTP servers. ADS was configured to use DHCP and PXE on the same machine.

The MiniCore server deployment service provides an environment for in-place and staged image deployment. In-place image deployment refers to a delivery mechanism that deploys directly onto the hardware located in the production environment. Stage image deployment refers to a deployment that takes place at a designated staging area, and the server is then shipped to its final destination. Since the security policies limit traffic between the internal and other zones, in-place deployments are supported only for internal zone servers and staged deployments are used for all other servers, including those in the remote branch office sites.

In-place server builds are supported only for servers on the CIA, CIB, CIDF, CIF, CII, and CIM networks. For these networks, DHCP was configured to provide node addresses 100-130 for the target build machines with 4-hour lease times so the addresses could be quickly reclaimed. For staged deployments, the CIM network is used as the staging area. In this environment, ADS may be installed but not fully configured. For example, to reduce resource usage by the VHDs, the deployment server may not capture or maintain any images. However, this environment may be prepared to enable image-based server deployments.

Desktop Deployment Design

The MiniCore desktop deployment service may be implemented following the guidance described in the MSM Solution Accelerator for Business Desktop Deployment (BDD) 1.0 document titled Plan, Build, and Deploy Guide, which is herein incorporated by reference in its entirety. The deployment server FFL-NA-DEP-02 may be installed with Remote Installation Services (RIS), which provides PXE and TFTP servers. RIS was configured to interoperate with the main corporate DHCP server on FFL-NA-DC-01. Client desktop builds using RIS are supported on the CCN network in the FFL site. RIS-based deployments for the other client networks may not be supported because of bandwidth and firewall limitations.

In one embodiment of the MiniCore design, for deploying client desktops in the other sites, a semi-automated process can be used. Both DAL and WSG can initiate the deployment process using Windows Pre-installation Environment (WinPE) CD-ROMs and then use the local management server for accessing product distribution files for installing the operating system and layered products. Client desktops in the PIT site are deployed using either a staging area in the FFL site or a manual CD-ROM-based installation performed by the end-user.

Network Services

The MiniCore environment provides networks services as described in the MSA 2.0 Service Blueprints that include Domain Name System (DNS), Dynamic Host Configuration Protocol (DHCP), and Windows Internet Naming Service (WINS). The MiniCore design generally follows the same implementation design as described in the “Network Services” chapter of MSA 2.0 Planning Guide in the MSA Implementation Kit.

DNS Design

The DNS design for the MiniCore CDC site follows the DNS design from MSA 2.0 and the design considerations were the same as the CDC scenario as outlined in the MSA 2.0 Planning Guide. However, in the MiniCore, the client DNS services were consolidated onto the North America domain controller, FFL-NA-DC-01. In addition, to reduce resource usage, the environment does not implement a highly available DNS design. Instead, only one client DNS server was implemented. All domain controllers in the internal forest host a DNS server and use that server for name resolution.

DNS for the DAL and WSG BO sites may be configured on the site's domain controller. Local clients and servers use these DNS servers for name resolution to help reduce the WAN link bandwidth utilization. Because these sites have a domain controller in the same corporate forest, the DNS updates are replicated using AD replication.

The MSA 2.0 and the MiniCore DNS design for the SBO site (PIT) requires DNS name resolution entirely from the CDC site. This design means that if the WAN link to the CDC site fails, all DNS lookups will fail. However, if the WAN link is down, access to the services is unavailable so DNS lookups would not be necessary until the link is restored. If the site design requirements changed in the future to include a direct Internet link, a local DNS server may be deployed at the site. The perimeter forest DNS is implemented the same as the MSA 2.0 scenario; however, redundant servers were not implemented and only the primary DNS server is implemented on the domain controller FFL-CP-DC-01.

The public Internet announce DNS service may be implemented the same as the MSA 2.0 scenario, except that only one DNS server is implemented on FFL-CP-DNS-01. To enable coordination of the DNS server publication through the external firewall FFL-SA-FWP-01, this server has load-balanced virtual IP added to its CPD network interface. This allows the external firewall to continue using the load-balanced virtual IP to forward server-published DNS requests.

The DNS caching-only server configuration on the external proxy may be implemented the same as the MSA 2.0 scenario. However, a root hint server pointing to FFL-INT-CLI-01 may be added to allow name lookups for emulated Internet zones.

A DNS server is installed on FFL-INT-CLI-01 and configured to host the root “.” zone. Forwarder NS records may be added to provide name lookups for contoso.com through the two server-published ns1 and ns2 IP addresses on the external firewall FFL-SA-FWP-01. Since FFL-INT-CLI-01 also hosts emulated web sites for fabrikam.com and wingtiptoys.com (as described in MSA 2.0), these DNS zones are hosted on this server.

DHCP Design

The DHCP design for one embodiment of the MiniCore CDC site follows the DHCP design from MSA 2.0 and the design considerations are similar to the CDC scenario as outlined in the MSA 2.0 Planning Guide. However, in one embodiment of the MiniCore, the client DHCP server may be consolidated onto the North America domain controller, FFL-NA-DC-01. In addition, to reduce resource usage, the environment may not implement the server failover cluster highly available DHCP design. Instead, only one client DHCP server may be implemented.

DHCP servers also exist to support the server and desktop deployment services. The scopes are separated between the different DHCP servers to prevent any overlap of configuration settings for the DHCP client. For the server deployment service, the DHCP server on FFL-NA-DEP-01 provides scope configuration settings for the CIA, CIB, CIDF, CIF, CII, and CIM networks. This deployment server, installed with ADS, contains PXE and TFTP servers to support PXE-based server deployments. The desktop deployment server, installed with RIS, also contains PXE and TFTP servers to support PXE-based desktop deployments to the CCN network.

The WSG and PIT remote sites may not have enough local clients to warrant installing a DHCP server locally. The client desktop networks in these sites, WCN and PCN, obtain DHCP scope configurations from the main corporate DHCP server on FFL-NA-DC-01. The DAL site, which has enough local clients, has a DHCP server consolidated on the local site domain controller, DAL-NA-DC-01. This DHCP server provides scope configurations for only the local desktop client network, DCN.

WINS Design

The WINS design for the MiniCore CDC site may follow the WINS design from MSA 2.0 and the design considerations are similar to the CDC scenario as outlined in the MSA 2.0 Planning Guide. However, in one embodiment of the MiniCore, the WINS server may be consolidated onto the North America domain controller, FFL-NA-DC-01. In addition, to reduce resource usage, the environment may not implement the server failover cluster highly available WINS design. Further, the replica WINS server in the MSA 2.0 scenario design may not be implemented at the CDC site. Instead, only one WINS server may be implemented and that server is defined as the hub server for the replication topology to the spoke servers in the other sites.

The WSG and PIT remote sites may not have enough local clients to warrant installing a WINS server locally. All server and desktop machines at these sites interact with the main corporate WINS server on FFL-NA-DC-01. The DAL site, which may have enough local clients, includes a WINS server consolidated on the local site domain controller, DAL-NA-DC-01. This WINS server may be configured as a spoke server to the hub server in the CDC site. The server and desktop machines at this site use the local WINS server to help resolve NetBIOS names.

In WINS, the WINS/NBT node type defines the method that clients use to identify NetBIOS-based names. There are four node types:
b-node (0x1): Broadcast for name resolution only.
p-node (0x2): Query WINS server for name resolution only.
m-node (0x4): Broadcast for name resolution first and then query WINS server.
h-node (0x8): Query WINS server first and then broadcast.

In sites where there is a WINS server local to the client, such as FFL and DAL, the client should be configured to use h-node (0x8). In sites where there are no WINS servers local to the client, such as WSG and PIT, the client should be configured to use m-node (0x4). These settings were defined in the DHCP server options for the appropriate client networks.

Firewall Services

In one embodiment, the MiniCore environment provides firewall services as described in the MSA 2.0 Service Blueprints that include firewall and proxy/cache services. The MiniCore design generally follows the same implementation design as described in the “Firewall Services” chapter of MSA 2.0 Planning Guide in the MSA Implementation Kit.

Perimeter Firewall Design

In one embodiment, the MiniCore perimeter firewall design follows generally the same design implemented for the MSA 2.0 scenario with some differences. Only one external firewall server is implemented on FFL-SA-FWP-01 with no redundancy or load balancing. All public virtual IP addresses from the MSA 2.0 scenario were assigned to the single external CPFi interface. The internal interface, CPSi, contains only its single static address and no virtual IP addresses. This single address is used as the default gateway for outbound traffic from the FFL-SA-RTR-07 router machine, which is similar to the design implemented in the MSA 2.0 scenario.

Full Web and DNS server publishing was implemented as in the MSA 2.0 scenario. Table 4 below shows the Web publishing rule configurations where the destination of the Web traffic is defined by the virtual IP address of the Web server farm. In the MiniCore, this is implemented as the single FFL-CP-WEB-01 virtual machine.

TABLE 4

| | | Port when |
|---|---|---|
| | | Bridging Request |
| Web Publishing Rule | Destination Set | as HTTP |
| Contoso.com | Contoso.com | 80 |
| Pki.contoso.com | Pki.contoso.com | 8080 |
| Secure.contoso.com | secure.contoso.com | 8081 |
| Nile.contoso.com | Nile.contoso.com | 8082 |
| petshop.contoso.com | petshop.contoso.com | 8083 |
| fmstocks.contoso.com | fmstocks.contoso.com | 8084 |
| PETSHOPWEBSERVICE.contoso.com | PETSHOPWEBSERVICE.contoso.com | 8085 |

DNS server publishing is configured to forward DNS requests to the virtual IP address of the DNS server farm. In the MiniCore, this is implemented as the single FFL-CP-DNS-01 server, which has the virtual IP address assigned to its CPD interface. The external firewall server is configured not to use DNS for name lookups. Names, especially public Internet names, are defined in the hosts file on the local machine. Therefore, when configuring the external firewall server for an outbound Web request, the external Web site host name should be defined in the local hosts file.

Internal Firewall Design

Unlike the MSA 2.0 scenario, which used a hardware solution, the MiniCore internal firewall design utilized several Windows Server 2003 virtual machines with ISA Server 2004 Standard Edition to implement the firewall security policies between each of the zones and networks. The full set of MSA 2.0 policies were implemented and enhanced with the addition of the branch office sites.

Multiple virtual machines were required because Virtual Server only allows up to four NICs per virtual machine. This increased the complexity of the design by creating several machines to support the interfaces to all the networks. However, because ISA 2004 supports multiple networks, the same firewall policy rules could be implemented on each of the virtual machines. Further, by implementing the firewall in virtual machines, a more simplified and consistent physical host design is realized.

The internal firewall is implemented on virtual machines FFL-SA-RTR-01, FFL-SA-RTR-02, FFL-SA-RTR-03, FFL-SA-RTR-04, FFL-SA-RTR-05, FFL-SA-RTR-06, and FFL-SA-RTR-08. Comparing to the MSA 2.0 scenario, FFL-SA-RTR-01, FFL-SA-RTR-02, FFL-SA-RTR-03, and FFL-SA-RTR-08 implement the routing and firewall features of the FFL-CI-ACC-A & -B network devices. FFL-SA-RTR-04, FFL-SA-RTR-05, and FFL-SA-RTR-06 implemented the FFL-CI-CORE-A & -B network devices, which, in the MinCore, have been combined in an integrated firewall design.

All specific firewall policy settings can be found in the “Network Security” worksheet of the Configuration Matrix.

Proxy-Cache Design

The MiniCore proxy-cache design follows generally the same design implemented for the MSA 2.0 scenario with some differences. Only one external proxy server was implemented on FFL-SA-FWP-01 and only one internal proxy server was implemented on FFL-NA-PRX-01. No redundancy or load balancing was implemented on either the external or internal proxy servers.

In one embodiment, the MiniCore environment implements the same tiered proxy design as the MSA 2.0 scenario where internal clients use the internal proxy FFL-NA-PRX-01, which then routes external requests to the external proxy server FFL-SA-PRX-01. This design allows the external proxy server to operate without internal domain credentials, which reduces exposure to the Internet, while at the same time enabling user-based external site authorization rules. Since an array was not implemented for the internal proxy, the wpad DNS entry simply points to the single host address for the FFL-NA-PRX-01 proxy server.

Since the external proxy server FFL-SA-PRX-01 does not implement load balancing, the virtual IP on its internal side may not be assigned. The downstream routing destination setting on the internal proxy FFL-NA-PRX-01 is defined to forward requests to the host address of the CPSo internal interface of the external proxy.

The routing rules on FFL-NA-PRX-01 were modified from the MSA 2.0 scenario design. Rather than create a special routing rule for external requests, the default routing rule was modified to forward all requests except those for defined internal sites. With this change, a web client that doesn't use the wpad DNS name to locate the proxy server, can use the internal proxy server for all Web requests, both internal and external. Internal clients that use wpad to discover the internal proxy server will continue to receive from the proxy server the bypass list of internal sites as part of the discovery process.

Clients in the branch offices do not have direct access to the Internet so external Web requests are routed through the proxy server in the FFL site. Client proxy server discovery is configured through the wpad DNS entry and clients receive proxy and site bypass settings through this process.

Directory Services

In one embodiment, the MiniCore environment provides directory services as described in the MSA 2.0 Service Blueprints. The MiniCore design generally follows the same implementation design as described in the “Directory Services” chapter of MSA 2.0 Planning Guide in the MSA Implementation Kit. The design also used guidance from the Microsoft document entitled Windows Server 2003 Deployment Kit: Designing and Deploying Directory and Security Services, which is herein incorporated by reference in its entirety.

Forest Design

In one embodiment, the MiniCore forest design follows the same design implemented for the MSA 2.0 scenario. Two forests were created to isolate resources, one for the internal corporate zone and one for the perimeter zone.

Domain Design

In one embodiment, the MiniCore domain design follows the same design implemented for the MSA 2.0 scenario. The perimeter forest uses the single forest domain model, which is sufficient for management of perimeter servers. The internal forest is based on the multiple regional domain model. In the MiniCore implementation, the only internal domain created was North America (NA); however, Europe and Asia Pacific can be implemented if necessary.

DNS Namespace Design

In one embodiment, the MiniCore DNS namespace design follows generally the same design implemented for the MSA 2.0 scenario. The namespace contoso.com is the external namespace. The forest root for the perimeter uses perimeter.contoso.com. Internally, the forest root namespace is corp.contoso.com. Each regional domain is a child in the same hierarchy of the corp.contoso.com namespace with na.corp.contoso.com, eu.corp.contoso.com, and as.corp.contoso.com for North America, Europe, and Asia Pacific domains, respectively.

NetBIOS Namespace Design

In one embodiment, the MiniCore NetBIOS namespace design follows generally the same design implemented for the MSA 2.0 scenario. The internal corporate root NetBIOS name is changed to CONTOSOCORP from CORP. This is done as CORP is commonly recommended for corporate forest root NetBIOS namespaces. In the event of an acquisition, a NetBIOS name conflict would occur if two forest roots had used CORP as the chosen NetBIOS namespace.

In all other cases, the default NetBIOS namespace is used from the DNS namespace design. Therefore PERIMETER, NA, EU, and AS are chosen as the NetBIOS names for the perimeter, North America, Europe, and Asia Pacific domains, respectively.

Organizational Unit Design

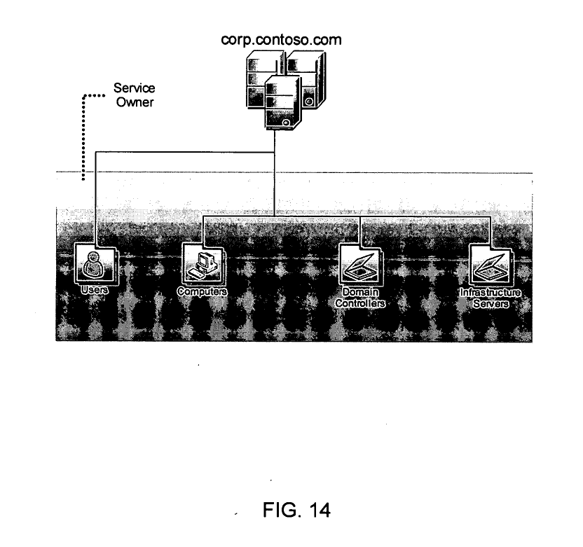

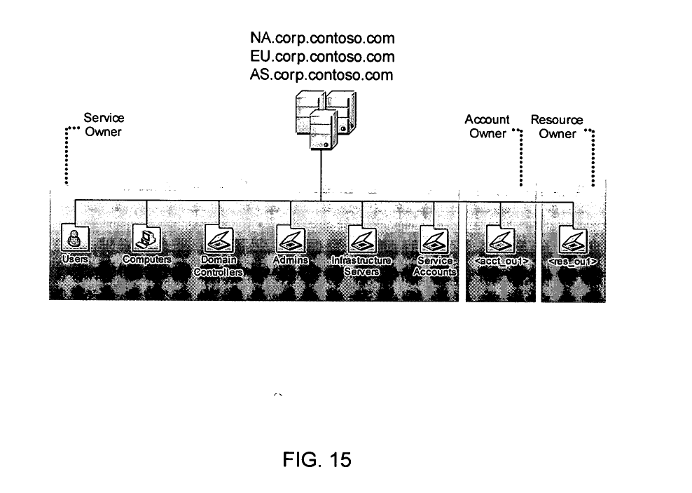

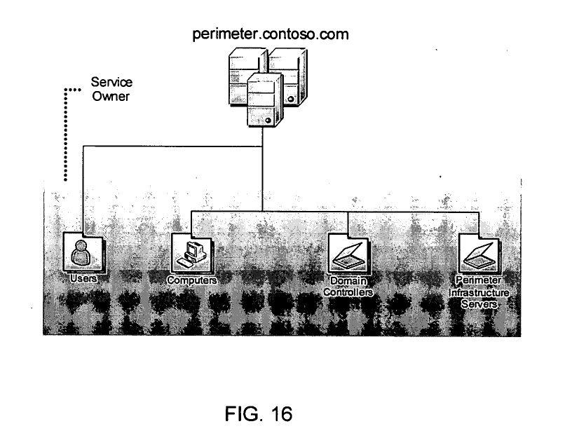

In one embodiment, the MiniCore Organization Unit (OU) design follows generally the same design implemented for the MSA 2.0 scenario. The OU design chosen for the scenario is primarily object-based. The OU structure is replicated in its entirety in each of the regional domains, while a subset of the OU structure is created in the forest root. The primary function of the OU is to group objects for the purpose of management. Administrators can use OUs to create a hierarchical management structure for the organization. FIG. 14 depicts the OU design that was chosen for the top tier of the CORP domain. FIG. 15 depicts the internal OU design used for the top tier of the North America, Europe, and Asia Pacific domains from MSA 2.0. This design was implemented for the NA domain in the MiniCore environment. FIG. 16 depicts the perimeter OU design used for the top tier of the Perimeter domain.

The gray area in FIGS. 14-16 represent an area of administration. The service owner manages the infrastructure and domain controllers. Additional account OUs can be created for identity management whenever required. The resource OUs are analogous to resource domains. The MiniCore environment implements the same OU hierarchy as the MSA 2.0 scenario including all the OUs for the infrastructure servers. This allows servers to be added to the environment and existing OUs reused for services that may be added.

Site Topology Design

In one embodiment, the MiniCore site topology design follows the same design implemented for the MSA 2.0 scenario with some differences. The MiniCore site topology is slightly different from the MSA 2.0 scenario in that the London site was not implemented and the following four sites were: Fairfield, Conn. (FFL); Dallas, Tex. (DAL); Washington, D.C. (WSG); and Pittsburgh, Pa. (PIT). These four sites represent the CDC, a large branch office, a small branch office and a satellite branch office, respectively. Different from the MSA 2.0 design, each branch office was implemented as a spoke to the CDC hub site in FFL. The DAL site link in the MiniCore is directly connected to FFL instead of Houston (HOU).

Guidance for designing the site topology for Active Directory is covered in detail in the “Designing the Site Topology” chapter of the Designing and Deploying Directory and Security Services book in the Windows Server 2003 Deployment Kit.

Operations Master Roles Placement Design

In one embodiment, the MiniCore site topology design follows the same design implemented for the MSA 2.0 scenario. The operations master roles placement for each of the domains in the MiniCore environment is listed in Table 5.

TABLE 5

| Master Role Holder | Domain | Operations Master Roles |
|---|---|---|
| FFL-RT-DC-01 | corp.contoso.com | Primary Domain Controller |
| | | (PDC) emulator master |
| | | Relative ID (RID) master |
| | | Infrastructure master |
| | | Schema master |
| | | Domain naming master |
| FFL-NA-DC-01 | na.corp.contoso.com | PDC emulator master |
| | | RID master |
| | | Infrastructure master |
| FFL-CP-DC-01 | perimeter.contoso.com | PDC emulator master |
| | | RID master |
| | | Infrastructure master |
| | | Schema master |
| | | Domain Naming master |

The enterprise site FFL was chosen as the location of the operations role holders because it hosts the well-connected network hubs for the North America region.

Domain Controller Placement Design

In one embodiment, the MiniCore domain controller (DC) placement design follows the same design implemented for the MSA 2.0 scenario with some differences. To reduce resource usage in the MiniCore environment, only one domain controller per domain is created per site that requires a domain controller. The FFL site has one domain controller for each of the perimeter.corp.contoso.com, corp.contoso.com and na.corp.contoso.com domains.

Considering the WAN link bandwidth and the number of supported users, the DAL and WSG sites each requires a domain controller for the na.corp.contoso.com domain. The domain controllers in each of these sites provide directory services to the clients in those sites. Based on the current support user sizing estimates, there is sufficient bandwidth available for DC replication from the CDC to the branch office.

The PIT site may not have enough users to require a local domain controller. This site obtains all directory services from the FFL site. In the event of a WAN link failure, directory resource access may be disrupted. Table 6 is a completed Domain Controller Placement Job Aid that shows the domain controller placement for the corp.contoso.com forest.

TABLE 6
Domain Controller Placement

| | | Users | Domain | |
|---|---|---|---|---|
| | | per | Con- | |
| | | Domain | troller | |
| | | per | Needed | |
| | Domains in | Loca- | (Yes/ | Domain |
| Location | Location | tion | No) | Controller Type |
| Fairfield, CT | corp.contoso.com | 7,000 | Yes | CONTOSOCORP |
| USA | na.corp.contoso.com | | Yes | Forest Root |
| | | | | Global Catalog |
| | | | | PDC emulator |
| | | | | master (NA) |
| | | | | Global Catalog |
| | | | | NA Regional |
| Dallas, TX | na.corp.contoso.com | 250 | Yes | NA regional |
| USA | | | | Global Catalog |
| Washington, | na.corp.contoso.com | 75 | Yes | NA regional |
| DC USA | | | | Global Catalog |
| Pittsburgh, | na.corp.contoso.com | 5 | No | |
| PA USA | | | | |

Table 7 is a completed Domain Controller Placement Job Aid that shows the domain controller placement for the perimeter.contoso.com forest.

TABLE 7
Domain Controller Placement

| | | Users | | |
|---|---|---|---|---|
| | | per | Domain | |
| | | Domain | Controller | Domain |
| | | per | Needed | Controller |
| Location | Domains in Location | Location | (Yes/No) | Type |
| Fairfield, CT | perimeter.contoso.com | Computer | Yes | Perimeter |
| USA | | Accounts | | forest root |
| | | Only | | Global |
| | | | | Catalog |
| | | | | PDC |
| | | | | emulator |
| | | | | master |
| | | | | (PERIM- |
| | | | | ETER) |

Guidance for designing domain controller placement and capacity is described in the “Planning Domain Controller Capacity” chapter of the Designing and Deploying Directory and Security Services book of the Windows Server 2003 Deployment Kit, which is herein incorporated by reference in its entirety.

Security Application Design

In one embodiment, the MiniCore security application design follows the same design implemented for the MSA 2.0 scenario with some differences. Group policy templates included in the download for the Windows Server 2003 Security Guide are applied at the domain and OU level. The MiniCore environment implements the same policies on the same OUs as MSA 2.0, except where it is necessary to enable certain functionality to work properly.

For example, since DNS, WINS, and DHCP may be consolidated onto the domain controllers, the domain controllers OU also apply policy templates to enable these services.

Other policy templates may be created to enable the installation of the Virtual Server Additions onto the perimeter and external firewall and proxy servers. Some patch update programs require the installation user to have the seDebug right assigned. A policy override template is created to grant this right to the Administrators group for the perimeter and external firewall and proxy servers.

Table 8 shows the templates and policies applied to each of the OUs in the corp.contoso.com forest. The order presented is the order in which the policies are applied to the OUs. This order ensures policy overrides occur correctly.

TABLE 8

| Policy Name | Template | Location |
|---|---|---|
| MSA Application Server | Enterprise | na.corp.contoso.com\MSA Infrastructure |
| Policy (MSS) | Client - IIS | Servers\Application Servers |
| | Server.inf | |
| MSA Application Server | MSA IIS | na.corp.contoso.com\MSA Infrastructure |
| Override | Override.inf | Servers\Application Servers |
| MSA Domain Account | Enterprise | corp.contoso.com |
| Policy (MSS) | Client - | na.corp.contoso.com |
| | Domain.inf | |
| MSA Server Baseline | Enterprise | corp.contoso.com\MSA Infrastructure |
| Policy (MSS) | Client - | Servers |
| | Member | na.corp.contoso.com\MSA Infrastructure |
| | Server | Servers |
| | Baseline.inf | |
| MSA Certificate | Enterprise | corp.contoso.com\MSA Infrastructure |
| Authority Policy (MSS) | Client - | Servers\Certificate Authority Servers |
| | Certificate | |
| | Services.inf | |
| MSA Certificate | MSA | corp.contoso.com\MSA Infrastructure |
| Authority Override | Certificate | Servers\Certificate Authority Servers |
| Policy | Authority | |
| | Override.inf | |
| MSA Cluster Override | MSA Cluster | na.corp.contoso.com\MSA Infrastructure |
| Policy | Override.inf | Servers\Database Servers\Database Clusters |
| | | na.corp.contoso.com\MSA Infrastructure |
| | | Servers\DHCP & WINS Consolidated |
| | | na.corp.contoso.com\MSA Infrastructure |
| | | Servers\File Servers |
| | | na.corp.contoso.com\MSA Infrastructure |
| | | Servers\Print Servers |
| MSA Database Override | MSA | na.corp.contoso.com\MSA Infrastructure |
| Policy | Database | Servers\Database Servers |
| | Servers | |
| | Override.inf | |
| MSA Domain Controller | Enterprise | corp.contoso.com\Domain Controllers |
| Policy (MSS) | Client - | na.corp.contoso.com\Domain Controllers |
| | Domain | |
| | Controller.inf | |
| MSA Domain Controller | MSA Domain | na.corp.contoso.com\Domain Controllers |
| Override Policy | Controller | |
| | Override.inf | |
| MSA Deployment | No override | na.corp.contoso.com\MSA Infrastructure |
| Server Policy | policy; | Servers\Deployment Servers |
| | inherits policy | |
| | from the MSA | |
| | Server | |
| | Baseline | |
| | Policy (MSS) | |
| MSA DHCP Policy | Enterprise | na.corp.contoso.com\MSA Infrastructure |
| (MSS) | Client - | Servers\DHCP (Standalone) Servers |
| | Infrastructure | |
| | Server.inf | |
| MSA DHCP & WINS | Enterprise | na.corp.contoso.com\MSA Infrastructure |
| Consolidated Policy | Client - | Servers\DHCP & WINS Consolidated |
| (MSS) | Infrastructure | |
| | Server.inf | |
| MSA DNS Override | MSA DNS | na.corp.contoso.com\MSA Infrastructure |
| Policy | Override.inf | Servers\DNS Servers |
| MSA File Policy (MSS) | Enterprise | corp.contoso.com\MSA Infrastructure |
| | Client - File | Servers\File Servers |
| | Server.inf | na.corp.contoso.com\MSA Infrastructure |
| | | Servers\File Servers |
| MSA File Server | MSA File | corp.contoso.com\MSA Infrastructure |
| Override Policy | Override.inf | Servers\File Servers |
| | | na.corp.contoso.com\MSA Infrastructure |
| | | Servers\File Servers |
| MSA Management | MSA | na.corp.contoso.com\MSA Infrastructure |
| Server Override Policy | Management | Servers\Management Servers |
| | Server | |
| | Override.inf | |
| MSA IIS Policy (MSS) | Enterprise | na.corp.contoso.com\MSA Infrastructure |
| | Client - IIS | Servers\Intranet Web Servers |
| | Server.inf | |
| MSA IIS Override | MSA IIS | na.corp.contoso.com\MSA Infrastructure |
| Policy | Override.inf | Servers\Application Servers |
| | | na.corp.contoso.com\MSA Infrastructure |
| | | Servers\Intranet Web Servers |
| MSA Print Policy | Enterprise | na.corp.contoso.com\MSA Infrastructure |
| (MSS) | Client - Print | Servers\Print Servers |
| | Server.inf | |
| MSA Print Server | MSA Print | na.corp.contoso.com\MSA Infrastructure |
| Override Policy | Server | Servers\Print Servers |
| | Override.inf | |
| MSA Proxy Override | MSA Proxy | na.corp.contoso.com\MSA Infrastructure |
| Policy | Server | Servers\Proxy Servers |
| | Override.inf | |
| MSA Radius Policy | Enterprise | na.corp.contoso.com\MSA Infrastructure |
| (MSS) | Client - IAS | Servers\Radius Servers |
| | Server.inf | |
| MSA Server Override | MSA Server | corp.contoso.com\MSA Infrastructure |
| Policy | Override.inf | Servers |
| | | na.corp.contoso.com\MSA Infrastructure |
| | | Servers |
| | | corp.contoso.com\Domain Controllers |
| | | na.corp.contoso.com\Domain Controllers |
| MSA WINS Policy | Enterprise | na.corp.contoso.com\MSA Infrastructure |
| (MSS) | Client - | Servers\WINS (Standalone) Servers |
| | Infrastructure | |
| | Server.inf | |
| MSA DHCP & WINS | Enterprise | na.corp.contoso.com\Domain Controllers |
| Policy | Client - | |
| | Infrastructure | |
| | Server.inf | |
| MSM Patch Override | MSM Patch | corp.contoso.com\Domain Controllers |
| Policy | Override | na.corp.contoso.com\Domain Controllers |
| | Policy.inf | corp.contoso.com\MSA Infrastructure |
| | | Servers |
| | | na.corp.contoso.com\MSA Infrastructure |
| | | Servers |

Table 9 shows the templates and policies applied to each of the OUs in the perimeter.contoso.com forest. The order presented is the order in which the policies are applied to the OUs. This order ensures policy overrides occur correctly.

TABLE 9

| Policy Name | Template | Location |
|---|---|---|
| MSA Perimeter | High Security - | perimeter.contoso.com\Perimeter |
| Application Server | IIS | Infrastructure Servers\Application Servers |
| Policy (MSS) | Server.inf | |
| MSA Perimeter | MSA IIS | perimeter.contoso.com\Perimeter |
| Application Override | Override.inf | Infrastructure Servers\Application Servers |
| Policy | | |
| MSA Perimeter Domain | High Security - | perimeter.contoso.com |
| Account Policy (MSS) | Domain.inf | |
| MSA Perimeter Base | High Security - | perimeter.contoso.com\Perimeter |
| Policy (MSS) | Member | Infrastructure Servers |
| | Server | |
| | Baseline.inf | |
| MSA Perimeter Domain | High Security - | perimeter.contoso.com\Domain Controllers |
| Controller Policy (MSS) | Domain | |
| | Controller.inf | |
| MSA Perimeter DNS | MSA DNS | perimeter.contoso.com\Perimeter |
| Override Policy | Override.inf | Infrastructure Servers\DNS Servers |
| MSA Management | MSA | perimeter.contoso.com\Perimeter |
| Server Override Policy | Management | Infrastructure Servers\Management Servers |
| | Server | |
| | Override.inf | |
| MSA Perimeter IIS | High Security - | perimeter.contoso.com\Perimeter |
| Policy (MSS) | IIS | Infrastructure Servers\Internet Web Servers |
| | Server.inf | |
| MSA Perimeter IIS | MSA IIS | perimeter.contoso.com\Perimeter |
| Override Policy | Override.inf | Infrastructure Servers\Internet Web Servers |
| MSA Server Override | MSA Server | perimeter.contoso.com\Domain Controllers |
| Policy | Override.inf | perimeter.contoso.com\Perimeter |
| | | Infrastructure Servers |
| MSM Patch Override | MSM Patch | perimeter.contoso.com\Domain Controllers |
| Policy | Override | perimeter.contoso.com\Perimeter |
| | Policy.inf | Infrastructure Servers |
| MSA Service Install | MSA Service | perimeter.contoso.com\Domain Controllers |
| Override Policy | Install | perimeter.contoso.com\Perimeter |
| | Override.inf | Infrastructure Servers |

Scenario Dependencies

The PIT SBO and the WSG BO are dependent on the FFL CDC resources. With respect to Active Directory, ensure the following to accommodate the additional workload of the SBO scenario:
Subnet objects representing the branch offices must be associated with the sites that host the centralized resources being accessed by the branch offices.
Sufficient capacity must exist on the domain controllers to support the additional load generated by the branch office sites.
Sufficient network capacity must exist between the branch offices and the sites hosting their resources to accommodate the load generated by users.
Additional users and groups may be added as the satellite branch offices come online.
   Infrastructure Management Services

In one embodiment, the MiniCore environment provides infrastructure management tools services as described in the MSA 2.0 Service Blueprints. The MiniCore design generally follows the same implementation design as described in the “Infrastructure Management Services” chapter of MSA 2.0 Planning Guide in the MSA Implementation Kit.

Infrastructure Management Services Design

In one embodiment, the MiniCore infrastructure management services design follows the same design implemented for the MSA 2.0 scenario with some differences. In each of the internal and perimeter zones, the management tools servers may be consolidated onto a single server for the zone. The management tools server for the internal zone is FFL-NA-MGT-01 and FFL-CP-MGT-01 provides support for the perimeter zone. To reduce VHD resource usage, each of these machines may not implement the definitive software library (DSL). Because MiniCore is designed, at least in part, for testing, Terminal Services and Terminal Services Licensing may not be implemented. Instead, the operating system built-in Remote Desktop service may be used to remotely access the management tools servers.

Added to the MiniCore environment are management servers, one each in the DAL and WSG sites. Both of these VMs, DAL-NA-MGT-01 and WSG-NA-MGT-01, are intended to provide tools support and access to local application product distribution files.

Internet Emulation

The Internet in the MiniCore may be emulated using a single virtual machine, FFL-INT-CLI-01. This VM is configured with RRAS to route between the CPFi and CPFo interfaces to simulate external proxy server requests for contoso.com public Web content. FFL-INT-CLI-01 is configured with IIS to publish a web site on each of its CPFo and CPFi interfaces to emulate a public Internet site for each the external proxy and firewall servers. Www fabrikam.com is published on the CPFi interface and www.wingtiptoys.com is published on the CPFo interface. Both sites are published on port 80 and lead to the same “under construction” page.

To enable DNS lookups to work correctly, FFL-INT-CLI-01 is configured with a DNS server and hosts the root “.” zone. Forwarder NS records are also implemented to allow name lookups for contoso.com, fabrikam.com, and wingtiptoys.com. Both fabrikam.com and wingtiptoys.com zones are hosted directly on FFL-INT-CLI-01.

Public Web Server

In one embodiment, the MiniCore includes a public Web server, which was built on FFL-CP-WEB-01. This server only hosts the www.contoso.com site on port 80. Other sites, such as pki.contoso.com, fmstocks.contoso.com, or secure.consoto.com, were not implemented on the web server; however, all the Web publishing rules are implemented on the perimeter firewall server, as described in “Creating a Web Publishing Rule” in the Firewall Services Build Guide of the MSA 2.0 Implementation Kit.

Although the FFL-CP-WEB-01 server was not built exactly the same as specified in the MSA 2.0 scenario, it was placed in the “Internet Web Servers” OU with the full MSA 2.0 scenario security policies. Even though load balancing is not implemented, the server has the virtual IP assigned to its CPF interface to allow web publishing by the external firewall to behave the same as the MSA 2.0 scenario.

Internal Clients

In one embodiment, the MiniCore environment includes test client virtual machines located on various client networks. All clients were installed with Windows XP SPI except FFL-NA-CLI-01, which was installed with Windows Server 2003 Standard Edition. For Windows XP clients, to reduce resource usage, a reduced installation of Office 2003 was implemented with Word, Excel, and Outlook.

All clients are configured for DHCP addressing and the DHCP server on FFL-NA-DC-01 was configured with reservations for each of the clients so that accessing the virtual machine through remote desktop would be predictable. Internet Explorer on each of the clients may be configured with default settings and can detect the proxy server using the wpad DNS entry.

Adapting MiniCore

By using virtual machine technology, an IT organization can maintain a working simulation of their production environment on significantly less hardware resources. It is ideally suited for testing updates, such as patches, prior to performing them on a production environment. The virtual environment, in whole or part, can be easily replicated or restored as necessary to achieve a test scenario. This can also be useful for IT staff training to improve troubleshooting and issue response.

Development teams that create products for customers can use the environment as a sample scenario to validate that the product has the right features and meets the needs of an enterprise customer. Development teams that create products for the internal corporation can use the environment to design and validate that the application adheres to the corporate infrastructure and security policies prior to deploying it to the production environment.

Reducing the Environment

The resource usage may be reduced by reducing the number of virtual machines to only those required by a test scenario. For example, if only an internal corporate environment is without access to the Internet and with no branch offices is needed, the environment may be reduced down to the domain controllers FFL-RT-DC-01 and FFL-NA-DC-01, the internal client FFL-NA-CLI-01, and a single router, FFL-SA-RTR-01. Using just these four VMs, a small corporate environment on a single host machine may be virtualized and operated without requiring an external network switch device.

When reducing the environment, the services needed to meet the objectives of a test scenario should be considered and compared with the functionality required by each service in the MiniCore environment. For example, the external proxy may be required if Internet access by internal corporate clients is to be tested. The perimeter machines may be required if corporate client access to public-facing Web or DNS services is to be tested.

Appropriate router machines should be provided when minimizing the number of virtual machines. Tracing the path between the machines will expose the routers that enable network traffic between them. Unless new machines are to be added to the appropriate networks, FFL-SA-RTR-02 and FFL-SA-RTR-08 router VMs may not be needed. Also, if branch offices are not implemented, FFL-SA-RTR-04 and FFL-SA-RTR-05 routers may not be needed.

Changing WAN Settings

The WAN simulator may be installed and configured on the router virtual machines at each of the branch offices to limit link speed, induce latency, and drop packets as appropriate. If these settings are inconsistent with an intended test scenario, they may be adjusted as appropriate.

Adding a Branch or Satellite Branch Office Site

If a test scenario calls for more branch offices, the existing branch office design may be used as a model for replicating to new sites. The DAL and WSG sites each have a domain controller and other network services. To reduce resource usage, as in the MiniCore, the network services may be consolidated onto the domain controller. Each branch office includes three local networks to emulate traffic partitioning for infrastructure, management, and clients. These networks may be consolidated for a given scenario.

To connect new branch office sites to the corporate network, new corporate router VMs may be added and connected through the FFL-SA-RTR-04 router. This router VM may act as the root router for all WAN links. Because of the network adapter limitations of Virtual Server, several router VMs may be daisy-chained to implement a desired scenario. OSPF should be implemented on the new router VMs. Each of the corporate router VMs may use ISA 2004 to firewall traffic between the remote sites and the corporate site. ISA 2004 may be installed on the new router VMs and the policies updated on the existing router VMs to allow network traffic to flow correctly.

Adding a New Internal Forest Domain

The MiniCore environment may be created with a root domain and single child domain for the North America region. If additional child domains are required, the appropriate domain controller virtual machines may be built as discussed in the “Directory Service” chapter of the Build Guide in the MSA 2.0 Implementation Kit. The child domain controllers should be built first in the FFL site connected to the CII network so access to the root domain controller is more predictable.

Adding Internet Hosts

As discussed above, the perimeter firewall may not support external name lookups through DNS. If the perimeter firewall requires access to new Internet hosts, local hosts file should be updated with the names and addresses of the external machines. If a scenario calls for accessing sites from the external proxy server FFL-SA-PRX-01, the DNS server on FFL-INT-CLI-01 may need to be updated to include the necessary zones or NS forwarder records so the external proxy can locate the sites.

Adding Public Web Sites

The perimeter firewall server FFL-SA-FWP-01 is configured with several Web publishing rules for public web sites hosted in the contoso.com environment. If a site that responds to the existing Web publishing rules is desired, the FFL-CP-WEB-01 virtual machine may be configured with a new Web site and connected to the appropriate TCP port as defined by the publishing rule. If a new site is desired, the site may be created on either FFL-CP-WEB-01 or a new VM and added to the Web publishing rules on the perimeter firewall server.

Connecting to the Internet

As discussed above, it is possible to connect the MiniCore to the real Internet for testing certain functionality. In following the MSA 2.0 scenario design, only the CPFi and CPFo networks are connected to the Internet. To connect the CPFo network to the Internet, the external proxy server FFL-SA-PRX-01 may be modified, as outlined below.
Change the IP address settings for the CPFo NIC to the appropriate values for your Internet direct tap (DTAP). The DNS settings may also be changed to use one or more DNS servers that can resolve public Internet names.
If the new Internet tap uses DNS forwarders to resolve public Internet names, modify the DNS service properties to forward the requests to the DNS forwarder servers.
Create new IP Packet Filter policies to filter traffic from the new CPFo interface IP address. The following list of existing policies may be used to create the new policies, but “-DTAP” should be added to the name so that it is unique. Apply the filter rule to the new CPFo IP address. Keep the old policies, but disable them.
Block H.323 requests
DNS Filter

To connect the CPFi network, the external firewall server FFL-SA-FWP-01 may be modified, as outlined below.
Change the IP address settings for the CPFi NIC to the appropriate values for the Internet direct tap (DTAP).
Update the local hosts file so the firewall server can locate any external Web sites for access by the perimeter Web server.
Change the Incoming Web Requests settings so the server will accept Web requests on the new IP addresses.
Change the Server Publishing Rules for DNS to accept requests on the new IP addresses.

The corporate security administrator should be consulted and the corporate security policies reviewed before connecting the MiniCore network environment to the Internet. Although the environment implements firewalls on both the CPFi and CPFo interfaces, a MiniCore implementation should comply with corporate policies.

Adding New Services

MiniCore supplies a base set of enterprise services to which any desired new services or functionality may be added. For example, a monitoring management service or a multi-tiered Web application service may be added. When planning new services are planned, the effect to the logical, physical, and security designs should be considered. The MSA 2.0 Reference Architecture Kit documentation may be used to help determine how to fit a new service into the overall enterprise architecture. Generally, for services described in the MSA 2.0 documentation, the services may be added by following the guidance in the appropriate Build Guide.

Adding New Machines

When adding a new service, it should be decided whether the service will be implemented using physical or virtual machines. Adding physical machines can be accomplished by connecting the network adapters for the machine to the appropriate VLAN exposed through the network switch. All routing and firewall filtering is handled by the router-firewall VMs. Adding virtual machines is similar to adding physical machines except the physical host machine's network adapters are connected to the appropriate VLANs on the network switch and the virtual networks are attached to the correct host network adapter.

Installing the operating system and layered products is the same on a virtual machine as it is for a physical machine. It is also possible to access the layered product installation files using remote desktop from the host to the virtual machine by enabling local disk device resources to be available.

Adding New Network Segments

If a test scenario requires adding new network segments, a new corporate router VM may be added to support the new segments. To allow network traffic to flow correctly to the new segments, the firewall policies may be modified appropriately.

Adapting the Active Directory Design

As discussed above, all the MSA 2.0 OUs were created and the appropriate group policies applied. When adding servers to the environment, the server should be moved to the appropriate OU. If an OU need to be added to the servers, create the OU in the Infrastructure Servers so that it will inherit the base MSA policies. Review the policy files provided in the MiniCore Build Files, SecurityPolicies folder and apply the appropriate policies to new OUs. If a new service policy updates, it is better to create new policy override files to allow the service to work than it is to update existing policies. This allows the base policy files to be updated without deleting overrides.

Modifying the Router-Firewall Policies

The firewall settings on the corporate router VMs may need to be modified to support a new service. When creating a new policy, define the source and destination filter elements using Subnet elements instead of creating Network elements. Network elements contain more configuration settings than simply an IP address range and will affect the firewall's determination of whether the network traffic is internal, external, or spoofed. Because the core internal firewall service is implemented on multiple router VMs, the policy updates may need to be applied to more than one VM. Create the policy element on one of the VMs and export the specific policy to a file. Then copy that file to the other router VMs and import the policy, placing it in the correct order position.

Device Naming

The following guidelines were used to define the device naming convention for the MiniCore environment. The naming convention applies to all network and computing devices in the environment, including physical and virtual computers.
The format should be easy to parse.
Names should help the reader when reading the guidance documentation.
Names should be as short as possible to make it easy to type the name into a text entry field or document.
Names should be unique across the entire enterprise to prevent NetBIOS name conflict.
Names should identify the location of the device.
The names should include the domain in which the device resides.
The convention should accommodate multifunction computers; that is, computers that perform more than one role, such as file, print, and Remote Installation Services (RIS).
The computer names should accommodate virtual functions such as network load balanced or failover cluster names.

For the MiniCore the names use the following format LLL-DD-[FFFF-SS|VVVVVV], where each field is described as in Table 10 below.

TABLE 10

| Field | Type | Description |
|---|---|---|
| LLL | Location | 3 alphabetic characters (e.g., SEA, LON) |
| DD | Domain | 2 alphabetic characters (e.g., NA, AS, EU) |
| FFFF | Function | 2-4 alphanumeric characters (e.g., DC, |
| | | SQL1, FIL, WEB) |
| SS | Sequence | 2 numeric characters (e.g., 01 thru 99) |
| VVVVVV | Virtual Name | 1-6 alphanumeric characters (e.g., SQL2I3, |
| | | WEBC4) |

Using dashes between the fields enables easier parsing of the name by automation tools and sorting for reporting or display interfaces. This also makes it easier on the reader to see the fields clearly separated. The domain field may be necessary since some sites will have multiple domains and it will help the operators identify in which domain the computer resides. Function names can include a number at the end to help identify a Network Load Balanced (NLB) or failover cluster. The sequence number is used to identify the unique node within the cluster. For example, -SQL3-02 would be node 2 of SQL cluster 3. Network devices that are not associated with a domain can use the domain placeholder values of ND or SA for network device.

### EXAMPLES

FFL-AS-DC-02

This server is the domain controller 02 for the Asia domain located in the Fairfield, Conn. USA location.

LON-EU-SQL213

This is a cluster virtual server name located in the London site and is part of the Europe domain. From the virtual server name, it is SQL Server instance 3 in the SQL2 failover cluster.

Table 11 defines the location codes used in the scenario.

TABLE 11

| | | | Office |
|---|---|---|---|
| Code | Location | Office Type | Size |
| ATL | Atlanta, GA USA | Sales office | 10 |
| BCL | Barcelona, Spain | Sales office | 5 |
| BEI | Beijing, China | Sales office | 5 |
| BGL | Bangalore, India | Research and development | 35 |
| BLM | Bloomington, IL | Insurance: P & C | 1,500 |
| | USA | | |
| BON | Bonn, Germany | Telecommunications | 2,500 |
| BRS | Brussels, Belgium | Government sales, European Union | 15 |
| | | location | |
| CAI | Cairo, Egypt | Sales office | 5 |
| CBM | Cambridge, MA | Education | 36 |
| | USA | | |
| CDR | Cedar Rapids, IA | Sales office | 5 |
| | USA | | |
| CLG | Calgary, Canada | Sales office | 14 |
| COP | Copenhagen, | Sales office | 15 |
| | Denmark | | |
| CRV | Caracas, Venezuela | Sales Office | 17 |
| DAL | Dallas, TX USA | Petroleum | 250 |
| DEN | Denver, CO USA | Sales office | 10 |
| DUB | Dublin, Ireland | Research and development | 100 |
| DUA | Dubai, United Arab | Sales office | 5 |
| | Emirates | | |
| EDB | Edinburgh, Scotland | Research, development and sales office | 40 |
| FFD | Fairfield, CT USA | Development department-specific | NA |
| FFH | Fairfield, CT USA | HR department-specific | NA |
| FFL | Fairfield, CT USA | Company headquarters and diversified | 7,000 |
| | | financials | |
| HKG | Hong Kong, China | Sales office | 5 |
| HOD | Houston, TX USA | Development department-specific | NA |
| HOU | Houston, TX USA | Airlines | 1,700 |
| HRT | Hartford, CT USA | Healthcare | 2,700 |
| INT | Internet | Any Internet Client | NA |
| KUL | Kuala Lumpur, | Research and development and Regional | 85 |
| | Malaysia | site | |
| LON | London, United | Research, development, sales office and | 250 |
| | Kingdom | regional site | |
| MEX | Mexico City, | Sales Office | 3 |
| | Mexico | | |
| MIA | Miami, FL USA | Sales office and regional site | 50 |
| MRS | Marseille, France | Research, development and sales office | 37 |
| MUN | Munich, Germany | Sales office | 5 |
| NWN | Newark, NJ USA | Sales office and regional site | 15 |
| NYC | New York, NY USA | Securities | 6,000 |
| ODS | Odessa, Russia | Petroleum location; research and | 5 |
| | | development | |
| PIT | Pittsburgh, PA USA | Sales office | 5 |
| RDU | Raleigh, NC USA | Sales office | 5 |
| ROM | Rome, Italy | Sales office | 5 |
| SAT | San Antonio, TX | Computers, Office Equipment | 3,450 |
| | USA | | |
| SEA | Seattle, WA USA | Software | 1,480 |
| SEO | Seoul, Korea | Sales Office | 9 |
| SFM | San Francisco, CA | Commercial banks (Embarcadero) | 245 |
| | USA | | |
| SFO | San Francisco, CA | Specialty retailing | 1,500 |
| | USA | | |
| SHI | Shiraz, Iran | Petroleum location | 2 |
| SNG | Singapore, | Research, development and sales office | 50 |
| | Singapore | | |
| STL | St. Louis, MO USA | Sales office | 10 |
| STU | Stuttgart, Germany | Development and sales office | 49 |
| SYD | Sydney, Australia | Research and development and Regional | 49 |
| | | site | |
| TAI | Taipei, Taiwan | Sales office | 5 |
| TLA | Tel Aviv, Israel | Sales office | 45 |
| TOK | Tokyo, Japan | Regional Site | 565 |
| TOR | Toronto, Canada | Sales office | 25 |
| WSG | Washington, DC | Government sales | 75 |
| | USA | | |

Table 12 defines the domain codes used in the scenario.

TABLE 12

| Code | Domain |
|---|---|
| AM | Americas |
| BD | Generic border |
| CP | CDC perimeter |
| DV | Development |
| EU | Europe |
| EF | Extranet Forest |
| HR | Human resources |
| ID | IDC interior |
| IN | Generic interior |
| IP | IDC perimeter |
| NA | North America |
| ND | Network device |
| PR | Generic perimeter |
| RT | Root |
| SA | Standalone, no domain affiliation |

Table 13 defines the function codes used in the scenario.

TABLE 13

| Code | Meaning |
|---|---|
| BAK | Backup |
| CLI | Client |
| DC | Domain controller (generic) |
| DEP | Deployment server |
| DHCP | DHCP Server |
| DNS | Domain name server (generic) |
| DNSA | Domain name server (announcer) |
| DNSR | Domain name server (resolver) |
| DSL | Definitive Software Library server |
| EXB | Exchange bridgehead server |
| EXF | Exchange front-end server |
| EXI | Exchange Internet server |
| EXM | Exchange mailbox server |
| EXP | Exchange public folders server |
| EXR | Exchange routing server |
| FAAC | SAN Fabric A Core Switch |
| FAAE | SAN Fabric A Edge Switch |
| FABC | SAN Fabric B Core Switch |
| FABE | SAN Fabric B Edge Switch |
| FIL | File server |
| FPS | File and print server |
| FWI | Firewall (internal) |
| FWP | Firewall (public) |
| HOST | Virtual Server host computer |
| IAS | Internet Authentication Service |
| | (RADIUS) |
| MGT | Management server (generic) |
| MSMQ | MSMQ server |
| MSP | Multiple service provider |
| NAS | Network Attached Storage server |
| NBR | Network border router |
| NSW | Network switch |
| NWAP | Network wireless access point |
| PKI | PKI server |
| PRN | Print server |
| PRX | Proxy server |
| PRXO | Inbound Outlook Web Access Proxy |
| | server |
| PXE | Preboot Execution Environment server |
| RTR | Network router |
| SMA | SAN Management Appliance |
| SITE | Site-to-site VPN server |
| SMTI | SMTP server (Windows, inbound) |
| SMTO | SMTP server (Windows, outbound) |
| SMTP | SMTP server (Windows, generic) |
| SQL | SQL database server (generic) |
| SQLM | SQL management server |
| SQLR | Replicated SQL server |
| UTL | Utility |
| VPN | Virtual Private Network server (RRAS) |
| VRS | Anti-Virus Software Services server |
| WEB | Web server |
| WINS | WINS server |

IP Addressing

The IP addressing scheme was devised using the following guidelines to allow for expansion of the environment in any of the networks as needed to test solutions.
The internal, perimeter, and client zones implements Internet classless addressing using the following ranges.
   10.x.x.x—Internal
   192.168.x.x—Perimeter
   172.16.x.x—Client, except for the Pittsburgh satellite branch office (SBO) which uses 10.205.1.0/27.
The definitions for the IP address octets are defined as follows.
   The second octet of the address defines the site.
   The third octet of the address defines the subnet.
   The fourth octet of the address defines the node within the subnet.
   Exception: For the perimeter and client zones, the third octet defines the combined site and subnet identifiers. For example, the Dallas client subnet is 172.16.116.0/24 where the Dallas site ID is 16 and the offset of 100 defines the client subnet ID.
Where possible, a full class C address range defines each subnet within a zone.
To accommodate non-router nodes, the WAN links use a subnet mask of 29 bits so that 6 nodes can be used, two for the router devices and possibly up to four for virtual machine host computers.
Other addressing for the environment is listed below.
   There are two emulated public Internet networks, one inbound to the firewall server (208.217.184.16/28) and the other outbound from the proxy server (208.217.184.32/27).
   The lab network, which supports remote desktop access to each virtual machine host computer, uses 192.168.172.0/24.

The details of the IP addressing for the environment sites and networks can be found in the “IP Segmentation” and “IP Addressing” worksheets of the Configuration Matrix.

User Accounts

The following criteria applies to user account types, described in the following subparagraphs.
Accounts are based on a user's legal name.
Nicknames, initials, only first name or only last name, are not allowed.
The account name contains 3-8 characters.
After the account is created, it can only be modified to reflect the following.
   Change in hire status.
   Legal name change.
   Other valid business reasons.

User account names use the following format.

[<type>-]<name>

The <name> field is created using a combination of letters from the first and last name, in consecutive order. For example, a user named John Doe might produce a <name> field value of johnd or, if already used, johndo.

The optional <type>-field is used for all non-full-time employees. Table 14 lists the different <type> field values and describes the users for which each applies. For the examples, the user's full name is John Q. Public. Several possible values are shown to illustrate how the name is adapted if an instance already exists.

TABLE 14

| User Type | <type> | | |
|---|---|---|---|
| Name | Value | Description | Examples |
| Full-time | Empty | A full-time employee is a legal | johnp |
| employee | | employee of the company. | johnpu |
| | | | johnpub |
| | | | johnpubl |
| Contingent | a | These user accounts support staff | a-johnp |
| Staff or | | provided by a third-party employer. | a-johnpu |
| Domestic | | Typically, the person works on-site | a-johnpub |
| Agency | | and is assigned to work in a | a-johnpubl |
| Temporary | | company facility. | |
| Worker | | | |
| Vendors and | v | These user accounts are for vendors | v-johnp |
| Independent | | and suppliers that an organization | v-johnpu |
| Contractors | | contracts for a predefined service | v-johnpub |
| | | or deliverable. | v-johnpubl |
| Business | b | These user accounts are for visiting | b-johnp |
| Guests | | researchers, collaborative work | b-johnpu |
| | | exchanges, and other forms of | b-johnpub |
| | | business guests of the organization. | b-johnpubl |
| Interns | t | These user accounts are for the | t-johnp |
| | | organization's paid, temporary interns | t-johnpu |
| | | and cooperative staff. | t-johnpub |
| | | | t-johnpubl |

By using the hyphen in the account name, administrative-support programs can easily parse and make decisions based on the type value.

Group Accounts

The name used for any domain level security group, whether universal, global, or domain local, should clearly reflect the ownership, division or team name, and business purpose of the group. For example, MSA-MiniCoreTesters or MSA_MiniCoreDeployment. Upon user request, the domain name or abbreviation may be placed at the beginning of the group name. For example, NA-MSA-MiniCoreTesters or CONTOSOCORP_MSA_MiniCoreDeployment.

It should be appreciated that the computer environment developed in accordance with MSA described above is used merely for example, and that the aspects of the invention are not limited for use on a computer environment of any particular architecture or configuration, as any computer environment may be virtualized. Similarly, the MiniCore described above refers to one embodiment of a core set of services, but that numerous other computer systems having the same or different services may be virtualized.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. It should be appreciated that any component or collection of components that perform the functions described above can be generically considered as one or more controllers that control the above-discussed function. The one or more controller can be implemented in numerous ways, such as with dedicated hardware, or with general purpose hardware (e.g., one or more processor) that is programmed using microcode or software to perform the functions recited above.

It should be appreciated that the various methods outlined herein may be coded as software that is executable on one or more processors that employ any one of a variety of operating systems or platforms. Additionally, such software may be written using any of a number of suitable programming languages and/or conventional programming or scripting tools, and also may be compiled as executable machine language code.

In this respect, it should be appreciated that one embodiment of the invention is directed to a computer readable medium (or multiple computer readable media) (e.g., a computer memory, one or more floppy discs, compact discs, optical discs, magnetic tapes, etc.) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

It should be understood that the term “program” is used herein in a generic sense to refer to any type of computer code or set of instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. In particular, various devices and components may be virtualized in any combination to provide a virtualized computer system.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing”, “involving”, and variations thereof herein, is meant to encompass the items listed thereafter and equivalents thereof as well as additional items.

What is claimed is:

1. A method of creating a virtualized computer environment that represents a real world computer environment, wherein the real world computer environment comprises a plurality of components, the plurality of components comprising a plurality of computer devices and at least one network device that implements a network that interconnects the plurality of computer devices, the real world computer environment comprising at least one security facility that implements at least one security function in the real world computer environment, the method comprising acts of:
including in the virtualized computer environment a virtualized representation of at least one of the plurality of computer devices in the real world computer environment; and
implementing the at least one security function in the virtualized computer environment.

2. The method of claim 1, wherein the at least one security function comprises a plurality of security functions, and wherein the act of implementing the at least one security function comprises an act of implementing the plurality of security functions in the virtualized computer environment.

3. The method of claim 1, further comprising an act of:
including in the virtualized computer environment a virtualized representation of the at least one network device in the real world computer environment.

4. The method of claim 3, wherein the act of including in the virtualized computer environment the virtualized representation of at least one of the plurality of computer devices comprises an act of including a virtualized representation of at least two of the plurality of computer devices in the real world computer environment.

5. The method of claim 4, wherein the act of including in the virtualized computer environment the virtualized representation of the at least one network device comprises an act of providing at least one virtualized network connection between the virtualized representation of the at least two computer devices.

6. The method of claim 4, wherein the act of including in the virtualized computer environment the virtualized representation of the at least one network device comprises an act of providing a virtualized representation of at least one switch or a virtualized representation of at least one router.

7. The method of claim 3, wherein the plurality of computer devices in the real world computer environment are distributed in a plurality of security zones, each of the security zones connected via the at least one network device, and wherein the at least one security function includes a plurality of security functions defining the plurality of security zones.

8. The method of claim 7, wherein the act of implementing the at least one security function includes an act of implementing the plurality of security functions to define the plurality of security zones in the virtualized computer environment.

9. The method of claim 5, wherein the act of including in the virtualized computer environment the virtualized representation of the at least two of the plurality of computer devices includes an act of hosting the virtualized representation of the at least two of the plurality of computer devices on at least one physical host computer device.

10. The method of claim 9, wherein the act of providing a virtualized representation of the at least one network device includes hosting the virtualized representation of the at least one network device on the at least one physical host computer device.

11. The method of claim 10, further comprising an act of providing access via a physical network to the at least one physical host computer device from at least one remote computer system.

12. The method of claim 11, wherein the at least one remote computer system is part of the real world computer environment.

13. The method of claim 11, wherein the at least one remote computer system is not part of the real world computer environment.

14. The method of claim 10, further comprising an act of connecting the at least one physical host computer device to the Internet.

15. The method of claim 10, wherein the act of hosting the virtualized representations of the at least two of the plurality of computer devices and the at least one network device comprises an act of hosting the virtualized representations on a single physical host computer device.

16. The method of claim 1, wherein at least one computer device in the real world computer environment is adapted to provide at least one service, and wherein the act of including in the virtualized computer environment the virtualized representation of the at least one of the plurality of computer devices comprises an act of implementing the at least one service on the virtualized representation of the at least one of the plurality of computer devices.

17. The method of claim 16, wherein the act of implementing the at least one service comprises an act of implementing at least one network service, at least one directory service, at least one database service, and at least one web service on the virtualized representation of the at least one computer device.

18. The method of claim 1, further comprising an act of:
including in the virtualized computer environment at least one of the components of the real world computer environment so that some portions of the real world computer environment are represented by virtualized representations in the virtualized computer environment and other portions of the real world computer environment are represented by real world components.

19. A computer readable medium encoded with a program for execution on at least one processor, the program, when executed on the at least one processor, performing a method of providing a virtualized computer environment that represents a real world computer environment, wherein the real world computer environment comprises a plurality of components, the plurality of components comprising a plurality of computer devices and at least one network device that implements a network that interconnects the plurality of computer devices, the real world computer environment comprising at least one security facility that implements at least one security function in the real world computer environment, the method comprising acts of:
providing in the virtualized computer environment a virtualized representation of at least one of the computer devices in the real world computer environment; and
performing the at least one security function in the virtualized computer environment.

20. The computer readable medium of claim 19, wherein the at least one security function comprises a plurality of security functions, and wherein the act of performing the at least one security function comprises an act of performing the plurality of security functions in the virtualized computer environment.

21. The computer readable medium of claim 19, further comprising an act of:
providing in the virtualized computer environment a virtualized representation of the at least one network device in the real world computer environment.

22. The computer readable medium of claim 21, wherein the act of providing a virtualized representation of at least one of the plurality of computer devices comprises an act of providing a virtualized representation of at least two of the plurality of computer devices in the real world computer environment.

23. The computer readable medium of claim 22, wherein the act of providing a virtualized representation of the at least one network device comprises an act of providing at least one virtualized network connection between the virtualized representation of the at least two of the plurality of computer devices.

24. The computer readable medium of claim 22, wherein the act of providing the virtualized representation of the at least one network device comprises an act of providing a virtualized representation of at least one switch or a virtualized representation of at least one router.

25. The computer readable medium of claim 21, wherein the plurality of computer devices in the real world computer environment are distributed in a plurality of security zones, each of the security zones connected via the at least one network device, and wherein the at least one security function comprises a plurality of security functions defining the plurality of security zones, and wherein the act of performing the at least one security function comprises an act of performing the plurality of security functions to define the plurality of security zones in the virtualized computer environment.

26. The computer readable medium of claim 22, in combination with at least one physical host computer device, wherein the computer readable medium is resident on the at least one physical host computer device.

27. The computer readable medium of claim 19, wherein the at least one computer device in the real world computer environment is adapted to provide at least one service, and wherein the act of providing the virtualized representation of the at least one computer device comprises an act of providing the virtualized representation of the at least one computer device such that the virtualized representation performs the at least one service.

28. An apparatus for deploying a virtualized environment that represents a real world computer environment, wherein the real world computer environment comprises a plurality of components, the plurality of components comprising a plurality of computer devices and at least one network device that implements a network that interconnects the plurality of computer devices, the real world computer environment comprising at least one security facility that implements at least one security function in the real world computer environment, the apparatus comprising:
at least one controller adapted to emulate at least two of the plurality of computer devices in the real world computer environment and to implement the at least one security function in the virtualized computer environment.

29. The apparatus of claim 28, wherein the at least one controller comprises means for emulating the at least two of the plurality of computer devices and means for implementing the at least one security function in the virtualized computer environment.

30. The apparatus of claim 28, wherein the at least one controller comprises at least one physical host computer device.

31. The apparatus of claim 30, in combination with at least one remote computer system, wherein the at least one remote computer system is connected via a physical network to the at least one physical host computer device.

32. A method of testing software to be executed on a real world computer environment that comprises a plurality of computer devices interconnected via a network that comprises at least one network device, the real world computer environment further comprising at least one security facility that implements at least one security function in the real world computer environment, the method comprising an act of:
executing the software on a virtualized computer environment that represents the real world computer environment, the virtualized computer environment comprising a virtualized representation of at least one of the computer devices in the real world computer environment and implementing the at least one security function in the virtualized computer environment.

33. The method of claim 32, wherein the software uses at least one service from the real world computer environment.

34. The method of claim 33, further comprising an act of implementing the at least one service on the virtualized representation of the at least computer device such that, when the software is executed, the virtualized computer environment performs the at least one service.

35. The method of claim 34, wherein the virtualized representation of the at least one computer device includes a virtualized representation of at least one server, and wherein the at least one service is implemented on the virtualized representation of the at least one server such that, when the software is executed, the virtualized representation of the at least one server performs the at least one service.

36. The method of claim 35, wherein the at least one service comprises at least one network service, and least one directory service and at least one web service.

37. The method of claim 32, wherein the virtualized computer environment comprises a virtualized representation of the at least one network device.

38. The method of claim 37, wherein the real world computer environment includes a security environment wherein the plurality of computer devices are distributed over a plurality of security zones, each of the plurality of security zones connected via the at least one network device, and wherein the at least one security function includes a plurality of security functions that define the security environment, and wherein the computer environment implements the plurality of security functions, the method further comprising an act of debugging the software in the security environment.

39. The method of claim 37, wherein the virtualized computer environment is hosted, at least in part, on at least one physical host computer device, the method further comprising an act of installing the software on the at least one physical host computer device.

40. The method of claim 10, wherein the at least one physical host computer device is capable of being accessed from at least one remote computer system.
